(19) United States
(12) Patent Application Publication
(10) Pub. No.: US 2025/0254163 A1
(43) Pub. Date: Aug. 7, 2025

(54) SYSTEM AND METHOD FOR SECURING ONBOARDING OF PERIPHERAL DEVICE NODES WITHIN A PERIPHERAL DEVICE WORKSPACE VIA ONLINE OR OFFLINE ATTESTATION

(71) Applicant: Dell Products, LP, Round Rock, TX (US)

(72) Inventors: Gokul Thiruchengode Vajravel, Bangalore (IN); Srinivasa Ragavan Rajagopalan, Bangalore (IN); Vivek Viswanathan Iyer, Saint Johns, FL (US)

(73) Assignee: Dell Products, LP, Round Rock, TX (US)

(21) Appl. No.: 18/429,739

(22) Filed: Feb. 1, 2024

(51) Int. Cl. H04L 9/40

(52) U.S. Cl. CPC H04L 63/0876; H04L 63/20

(57) ABSTRACT

A peripheral device workspace cloud orchestrator server includes a hardware processor, a power management unit to provide power to the hardware processor and memory device, and a network interface device to receive detected peripheral device enrollment data describing an introduced peripheral device node that has requested to be operatively coupled to an anchor information handling system node within a peripheral device workspace, the anchor information handling system node operatively coupled to the peripheral device workspace cloud orchestrator server and identified as being included within the peripheral device workspace. The hardware processor executed computer-readable program code of a node attestation service module to attest whether the introduced peripheral device node is a trusted node based on the received peripheral device enrollment data. The hardware processor executes computer-readable program code of a node authorization service module to provide operational entitlements that define the actions allowed by the introduced peripheral device node.

### FIELD OF THE DISCLOSURE

The present disclosure generally relates to automatic and secured onboarding of peripheral device nodes within a peripheral device workspace. The present disclosure more specifically relates to automatic and secured onboarding of peripheral device nodes within a peripheral device workspace by verifying and attesting to the security of a newly onboarded peripheral device with a trusted cloud service executing at a peripheral device workspace cloud orchestrator server or via trusted neighboring peripheral device workspaces depending on connectivity.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more applications such as workplace productivity applications or a gaming application. Further, the information handling system may be operatively coupled to a plurality of peripheral devices at a location with the information handling system being operatively coupled to a cloud server information handling system via a network connection.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an anchor information handling system node operatively coupled to a remotely located peripheral device workspace cloud orchestrator server according to an embodiment of the present disclosure;

FIG. 2 is a block diagram illustrating an anchor information handling system node of a peripheral device workspace operatively coupled to a remotely located peripheral device workspace cloud orchestrator server according to another embodiment of the present disclosure;

FIG. 3 is a flow chart showing a method of onboarding an introduced peripheral device node into a peripheral device workspace via a network connection and execution of code instructions at a peripheral device workspace cloud orchestrator server according to an embodiment of the present disclosure;

FIG. 4 is a flow chart showing a method of onboarding an introduced peripheral device node into a peripheral device workspace without a network connection between an anchor information handling system and a peripheral device workspace cloud orchestrator server via an alternate peripheral device workspace according to another embodiment of the present disclosure;

FIG. 5 is a flow chart showing a method of onboarding an introduced smart peripheral device node into a peripheral device workspace via a network connection according to another embodiment of the present disclosure; and

FIG. 6 is a flow chart showing a method of onboarding an introduced peripheral device node into a peripheral device workspace by selecting among execution of code instructions for peripheral device node attestation depending on network connectivity according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

A user may oftentimes use an information handling system at a physical location in a peripheral device workspace. In this context, a peripheral device workspace can be viewed as an environment that includes a user information handling system (e.g., a laptop) as an anchor information handling system node or primary node and one or more peripheral devices as peripheral device nodes also referred to as peripherals that are connected to the user information handling system at an identified location. The location of a peripheral device workspace and a manifest of these nodes at that location define a peripheral device workspace that is associated with a peripheral device workspace identification value. In an embodiment, each of the information handling systems and peripheral devices within these peripheral device workspaces may be referred to as node devices and form part of these peripheral device workspaces. According to embodiments herein, a formed peripheral device workspace may oftentimes be used for various work scenarios. For example, a business may have an office space that includes hoteling cubes that can be assigned to, reserved by, or otherwise utilized by the business' employees as peripheral device workspaces for use with one or more peripheral devices and an information handling system introduced to the peripheral device workspace for the duration it is used by the identified user, for example, a business' employee. In such an example case, the business may allow its individual employees to connect their laptops to a docking station or directly to one or more peripheral device nodes in a particular hoteling cube having a formed peripheral device workspace where various external peripherals may be available for use. The docking station, in some example embodiments, may be a smart peripheral device that includes a hardware processing device, a data storage device, and/or a wireless radio device capable of operatively coupling the docking station to a network in some example embodiments. Further, some peripheral device workspaces may be collaborative peripheral device workspaces, such as a conference room, where plural users may operate with shared peripheral device nodes as well as individual peripheral device nodes in an embodiment. Users may also employ other peripheral device workspaces when working from home or other locations and the information handling system and some portion of the external peripheral devices may travel with the user to one or more of the identified peripheral device workspaces that a particular user may enter and use. The plurality of peripheral device workspaces associated with or used by a user along with a user identification may define a user composite peripheral device workspace identifier for that user.

When a user is interacting with the anchor information handling system node the user may operatively couple a peripheral device to the anchor information handling system node and into a given peripheral device workspace at a location. This new peripheral device may be referred to herein as an introduced peripheral device node or, where the peripheral device is a smart device node, an introduced smart peripheral device node. This introduced peripheral device node may serve to allow the user to input data to or receive output from the anchor information handling system node within the peripheral device workspace. However, security issues may arise where the peripheral device is not a trusted peripheral device such as for the enterprise managing the peripheral device workspace. This may occur where, for example, the anchor information handling system node in a peripheral device workspace has access to secure data over a network and the peripheral device being operatively coupled to the anchor information handling system node has the ability to transmit data on its own or can download this secure data from the network with networking capability. After the introduced peripheral device node is operatively coupled to the anchor information handling system node in a peripheral device workspace via a bus, for example, the peripheral device must be verified and attested as being a trusted peripheral device before it is fully onboarded into the peripheral device workspace and is allowed to function as a peripheral device node within that peripheral device workspace within an enterprise's network.

The present specification describes a peripheral device workspace cloud orchestrator server that includes a network interface device to receive detected peripheral device enrollment data describing an introduced peripheral device node that has requested to be operatively coupled to an anchor information handling system node within a peripheral device workspace, the anchor information handling system node operatively coupled to the peripheral device workspace cloud orchestrator server and identified as being included within the peripheral device workspace. The hardware processor of the peripheral device workspace cloud orchestrator server executes computer-readable program code of a node attestation service module to attest whether the introduced peripheral device node is a trusted node based on the received peripheral device enrollment data. A search of a trusted peripheral device database by the peripheral device workspace cloud orchestrator server executing the attestation service module determines whether the peripheral device to be onboarded is trusted or not. Where the execution of the computer-readable program code of the attestation service module determines that the introduced peripheral device node is not trusted, the anchor information handling system node may be so notified and the introduced peripheral device node to be onboarded is prevented from access within the peripheral device workspace, for example, to prevent all data-path access to secure data such as that on the anchor information handling system node or located over a network. In an embodiment, the introduced peripheral device node may be prevented from providing input to or receiving output from the anchor information handling system node or otherwise blocking the functionalities of the introduced peripheral device node at the peripheral device workspace. Where the execution of the computer-readable program code of the attestation service module determines that the peripheral device is trusted, the hardware processor of the peripheral device workspace cloud orchestrator server may execute computer-readable program code of a peripheral device node authorization module to set and propagate entitlements of the peripheral device in order to include the peripheral device within the peripheral device workspace and be counted as a peripheral device node therein. The trusted peripheral device may then have an orchestrated device descriptor (ODD) assigned including the peripheral device identification data as well as configuration data, setting, operation contexts, session data, and link to telemetry for the peripheral device.

In some embodiments, the anchor information handling system node may not have access to the network and the peripheral device workspace cloud orchestrator server thereon in order to communicate with the peripheral device workspace cloud orchestrator server As such, when the user attempts to add a peripheral device to the peripheral device workspace, the computer-readable program code of the peripheral device node attestation service module and peripheral device node authorization module cannot be accessed to secure onboarding and attest to the trustworthiness of the introduced peripheral device node without a communication link to the introduced peripheral device node to be added. In an embodiment, the anchor information handling system node may complete this onboarding and attestation of trustworthiness of the introduced peripheral device node when communication access is not present with the peripheral device workspace cloud orchestrator server. In embodiments herein, the anchor information handling system node may leverage other anchor information handling system nodes or smart nodes associated with other peripheral device workspaces, instead, to determine whether the introduced peripheral device node should be onboarded and whether the introduced peripheral device node is trustworthy.

In an embodiment, the user's anchor information handling system node may execute computer-readable program code of peripheral device node attestation sub-agent that receives peripheral device workspace data related to other anchor information handling system nodes, such as at adjacent or other peripheral device workspaces via a peer discovery mechanism. These peer discovery mechanisms may include, for example, multicast DNS-based (mDNS-based) peer discovery clusters on a local area network (LAN), link layer discovery protocols (LLDPs), layer 2 neighbor discovery protocols, universal plug and play (UPnP) protocols, network basic input/output system (NetBIOS) and protocol, zero-configuration networking (ZeroConf) protocols, and the like. These types of protocols allow the user's anchor information handling system node to request or receive broadcasted peripheral device workspace data related to other users' peripheral device workspaces that may include a similar type, make, or model, as the introduced peripheral device node the user is attempting to operatively couple to the anchor information handling system node.

With this data, a similar process may take place where the hardware processor of the anchor information handling system node, or even a smart node, executes a peripheral device node authorization sub-agent to coordinate with the peripheral device node attestation service module executed on the peripheral device workspace cloud orchestrator server via another peripheral device workspace. This allows the hardware processor of the user's anchor information handling system node to block all data-path accesses of the introduced peripheral device node that is a candidate to be onboarded, retrieve peripheral device identification data from the introduced peripheral device node, verify that the other anchor information handling system nodes or smart nodes in another peripheral device workspace have securely onboarded a peripheral device node similar to the introduced peripheral device node in an embodiment. In some embodiments, the other anchor information handling system nodes in the other peripheral device workspaces may pass the peripheral device identification data onto the peripheral device workspace cloud orchestrator server for attestation that the introduced peripheral device node is a trusted peripheral device if available. Otherwise, if not available, limited access may be provided to the new, candidate peripheral device based on attestation from the nearby peripheral device workspace until final access to the peripheral device workspace cloud orchestrator server for attestation that the introduced peripheral device node is a trusted peripheral device is available.

In some embodiments, when one or more of the other users' anchor information handling system nodes at other peripheral device workspaces may have access to the peripheral device workspace cloud orchestrator server and may be able to, on behalf of the user's anchor information handling system node, pass this peripheral device identification data onto the peripheral device workspace cloud orchestrator server for such attestation and verification as described herein. Such results may be sent back to the user's anchor information handling system node as described herein in order to prevent or allow the introduced peripheral device node onboarding candidate to be included within the peripheral device workspace associated with the user. In an embodiment, when the user's anchor information handling system node gains access to the peripheral device workspace cloud orchestrator server again, the changes to the peripheral device workspace may be relayed to the peripheral device workspace cloud orchestrator server and associated with a peripheral device workspace identification value and stored on a peripheral device workspace database for later use by the peripheral device workspace cloud orchestrator server. Additionally, the now newly onboarded peripheral device may be assigned an orchestrated device descriptor (ODD) by the peripheral device workspace cloud orchestrator server that includes relevant information about the introduced peripheral device node such as peripheral device make, peripheral device model, peripheral device type, peripheral device connection type (e.g., wired or wireless), peripheral device wireless protocol type, peripheral device functionalities, and peripheral device settings, among other device descriptors.

In another embodiment, where the introduced peripheral device node being operatively coupled to the user's anchor information handling system node is a smart peripheral device and the anchor information handling system node is incapable of accessing the peripheral device workspace cloud orchestrator server, the introduced smart peripheral device may be used to gain access from a previous location or at the peripheral device workspace to the peripheral device workspace cloud orchestrator server via a network connection and get authorization, via a received token, to onboard the new peripheral device candidate into the peripheral device workspace associated with the user's anchor information handling system node. This may be done in a similar method as that described in connection with the user's anchor information handling system node with the introduced smart peripheral device requesting the secure token from the peripheral device workspace cloud orchestrator server to be used as later confirmation to the anchor information handling system node that the introduced smart peripheral device has been subjected to the attestation process described herein. In an example embodiment, the introduced smart peripheral device may send its own peripheral device identification data and a peripheral device identification associated with the user's anchor information handling system node to the peripheral device workspace cloud orchestrator server and, per execution of the peripheral device node attestation service module by the hardware processor of the peripheral device workspace cloud orchestrator server, have that peripheral device identification data compared to data maintained on the trusted peripheral device database. The results of this comparison are then provided to the peripheral device node authorization module executing on the peripheral device workspace cloud orchestrator server in order to provide the secure token (or not) to the introduced smart peripheral device for onboarding (or not) to the user's anchor information handling system node.

The systems and methods described herein, therefore, allows for secure onboarding of an introduced peripheral device node into a peripheral device workspace of which the user's anchor information handling system node is included. The systems and methods described herein also limits access to the introduced peripheral device node attempting to be onboarded onto the anchor information handling system node and within the peripheral device workspace prior to authorization to be included into the peripheral device workspace from the peripheral device workspace cloud orchestrator server. This is done so that there are no security issues that may arise during the operative coupling of the introduced peripheral device node to the anchor information handling system node. Still further, the systems and methods described herein allow for such processes whether the anchor information handling system node is online or offline relative to the peripheral device workspace cloud orchestrator server thereby allowing the user to operatively couple the introduced peripheral device node to the anchor information handling system node regardless of network status.

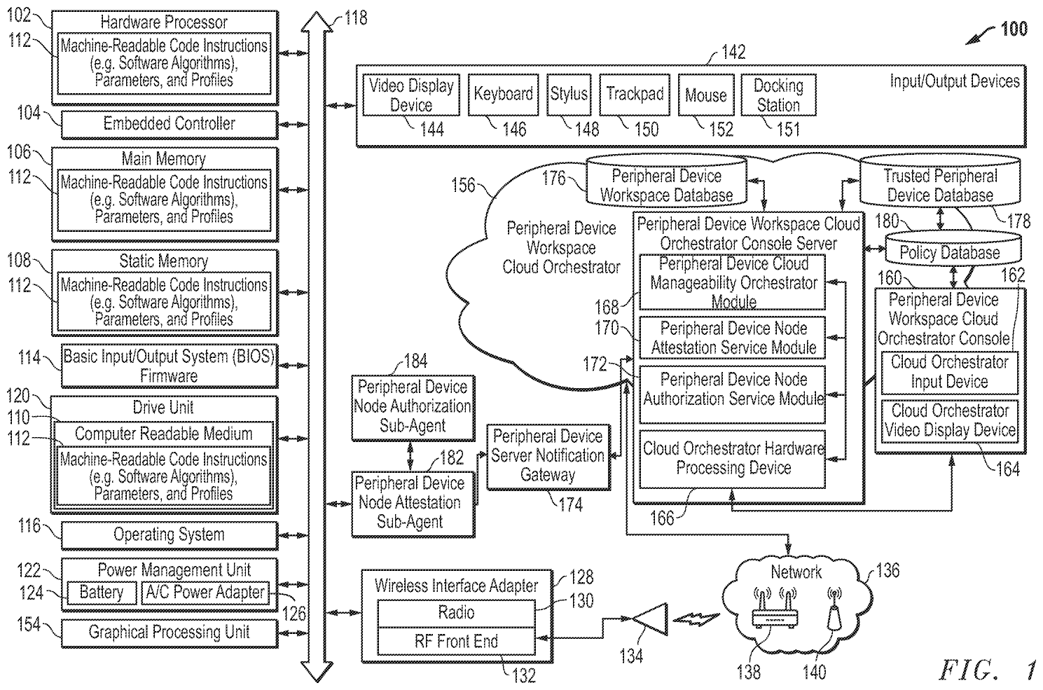

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 138, a base station transceiver 140, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality. It is appreciated that, in some embodiments herein, the information handling system 100 may be one of a plurality of device nodes as part of a peripheral device workspace and may be operatively coupled to a peripheral device workspace cloud orchestrator server or servers 158 executing one or more software modules of the peripheral device workspace cloud orchestrator 156 described herein. In these example, embodiments, the information handling system 100 is referred to as an anchor information handling system node 100 serving as a primary or anchor node within a peripheral device workspace. In another embodiment, one or more information handling systems similar to 100 may operate as one or more peripheral device workspace cloud orchestrator servers 158. In an embodiment, a cloud orchestrator consol 160 graphical user interface may be displayed at an information handling system 100 used by an internet technology decision maker (ITDM) to create hardware device operational policies with one or more peripheral device workspace cloud orchestrator servers 158 for the hardware device operational policies to be propagated down to node devices within a peripheral device workspace such as the peripheral device workspace associated with the anchor information handling system node 100, a docking station 151 (or other smart device node), video display device 144, keyboard 146, stylus 148, trackpad 150, mouse 152, and the like. In this embodiment, the anchor information handling system node 100, may receive the hardware device operational policies generated by the ITDM at the peripheral device workspace cloud orchestrator consol 160 graphical user interface via execution of code instructions of the peripheral device workspace cloud manageability orchestrator module 168 at the peripheral device workspace cloud orchestrator server 158 as described in embodiments herein.

In a networked deployment, the anchor information handling system node 100 may operate in the capacity of a client computer in a server-client network environment, or as a peer computer system in a peer-to-peer (or distributed) network environment. In an embodiment, the anchor information handling system node 100 may be implemented using electronic devices that provide voice, video, or data communication. For example, an anchor information handling system node 100 may be any mobile or other computing device capable of executing a set of instructions (sequential or otherwise) that specify actions to be taken by that machine. Further, while a single anchor information handling system node 100 is illustrated, the term “system” shall also be taken to include any collection of systems or sub-systems that individually or jointly execute a set, or plural sets, of instructions to perform one or more computer functions.

The anchor information handling system node 100 may include main memory 106, (volatile (e.g., random-access memory, etc.), or static memory 108, nonvolatile (read-only memory, flash memory etc.) or any combination thereof), one or more hardware processing resources, such as a hardware processor 102 that may be a central processing unit (CPU), a graphics processing unit (GPU) 103, embedded controller (EC) 104, or any combination thereof. Additional components of the anchor information handling system node 100 may include one or more storage devices such as static memory 108 or drive unit 120. The anchor information handling system node 100 may include or interface with one or more communications ports for communicating with external devices, as well as various input and output (I/O) devices 142, such as a docking station 151, a mouse 152, a trackpad 150, a keyboard 146, a stylus 148, a video/graphics display device 144, or any combination thereof. Portions of an anchor information handling system node 100 may themselves be considered peripheral device nodes as well as external, operatively coupled input and output (I/O) devices 142 as peripheral device nodes to anchor information handling system nodes 100 in some embodiments.

Anchor information handling system node 100 may include devices or modules that embody one or more of the devices or execute instructions for one or more systems and modules. The anchor information handling system node 100 may execute instructions (e.g., software algorithms), parameters, and profiles 112 that may operate on servers or systems, remote data centers, or on-box in individual client information handling systems according to various embodiments herein. In some embodiments, it is understood any or all portions of instructions (e.g., software algorithms), parameters, and profiles 112 may operate on a plurality of information handling systems 100.

The anchor information handling system node 100 may include the hardware processor 102 such as a central processing unit (CPU). Any of the processing resources may operate to execute code that is either firmware or software code. Moreover, the anchor information handling system node 100 may include memory such as main memory 106, static memory 108, and disk drive unit 120 (volatile (e.g., random-access memory, etc.), nonvolatile memory (read-only memory, flash memory etc.) or any combination thereof or other memory with computer readable medium 110 storing instructions (e.g., software algorithms), parameters, and profiles 112 executable by the EC 104, hardware processor 102, GPU 103, or any other hardware processing device. The anchor information handling system node 100 may also include one or more buses 118 operable to transmit communications between the various hardware components such as any combination of various I/O devices 142 as well as between hardware processors 102, an EC 104, the operating system (OS) 116, the basic input/output system (BIOS) 114, the wireless interface adapter 128, or a radio module, among other components described herein. In an embodiment, the anchor information handling system node 100 may be in wired or wireless communication with the I/O devices 142 such as a docking station 151, a keyboard 146, a mouse 152, video display device 144, stylus 148, or trackpad 150 among other peripheral devices.

The anchor information handling system node 100 further includes a video/graphics display device 144. The video/graphics display device 144 in an embodiment may function as a liquid crystal display (LCD), an organic light emitting diode (OLED), a flat panel display, or a solid-state display. It is appreciated that the video/graphics display device 144 may be wired or wireless and may be an external video/graphics display device 144 that allows a user to increase the desktop area by extending the desktop in an embodiment. Additionally, as described herein, the anchor information handling system node 100 may include or be operatively coupled to one or more other I/O devices 142 including the wired or wireless mouse 152 described herein that allows the user to interface with the anchor information handling system node 100 via the video/graphics display device 144, a cursor control device (e.g., a trackpad 150, or gesture or touch screen input), a stylus 148, and/or a keyboard 146, among others. Anchor information handling system node 100 may also be operatively coupled to a peripheral device 142 such as a docking station 151 or other smart peripheral device having a hardware processing device such as a hardware processor, microcontroller, or other hardware processing resource and which may further operatively couple to one or more additional peripheral devices 142. As described herein, each of these input/output devices 142 may each be a node device associated with the anchor information handling system node 100 and may be part of a peripheral device workspace defined and identified with a peripheral device workspace identification value via execution of the ecosystem manageability service module 168 and cloud manageability orchestrator module 166 as described herein. It is also appreciated that, during operation of the anchor information handling system node 100, the user may attempt to operatively couple additional wired or wireless peripheral devices to the anchor information handling system node 100 resulting to a new peripheral device node being created within the peripheral device workspace. Various drivers and hardware control device electronics may be operatively coupled to operate the I/O devices 142 according to the embodiments described herein. The present specification contemplates that the I/O devices 142 may be wired or wireless.

A network interface device of the anchor information handling system node 100 shown as wireless interface adapter 128 can provide connectivity among devices such as with Bluetooth® or to a network 136, e.g., a wide area network (WAN), a local area network (LAN), wireless local area network (WLAN), a wireless personal area network (WPAN), a wireless wide area network (WWAN), or other network. In an embodiment, this network 136 may be operatively coupled to or include a peripheral device workspace cloud orchestrator 156 that includes one or more servers (e.g., peripheral device workspace cloud orchestrator server 158) or other computing devices that provide computer system resources as described herein that allow for the creation of peripheral device workspaces and orchestration, onboarding attestation, and onboarding authorization of different peripheral device nodes within one or more peripheral device workspaces. In embodiments described herein, the wireless interface device 128 with its radio 130, RF front end 132 and antenna 134 is used to communicate with the wireless peripheral devices via, for example, a Bluetooth® or Bluetooth® Low Energy (BLE) protocols. In an embodiment, the WAN, WWAN, LAN, and WLAN may each include an AP 138 or base station 140 used to operatively couple the anchor information handling system node 100 to a network 136. In a specific embodiment, the network 136 may include macro-cellular connections via one or more base stations 140 or a wireless AP 138 (e.g., Wi-Fi), or such as through licensed or unlicensed WWAN small cell base stations 140. Connectivity may be via wired or wireless connection. For example, wireless network wireless APs 138 or base stations 140 may be operatively connected to the anchor information handling system node 100. Wireless interface adapter 128 may include one or more radio frequency (RF) subsystems (e.g., radio 130) with transmitter/receiver circuitry, modem circuitry, one or more antenna radio frequency (RF) front end circuits 132, one or more wireless controller circuits, amplifiers, antennas 134 and other circuitry of the radio 130 such as one or more antenna ports used for wireless communications via multiple radio access technologies (RATs). The radio 130 may communicate with one or more wireless technology protocols.

In an embodiment, the wireless interface adapter 128 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 128 can represent an add-in card, wireless network interface module that is integrated with a main board of the anchor information handling system node 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes instructions, parameters, and profiles 112 or receives and executes instructions, parameters, and profiles 112 responsive to a propagated signal, so that a hardware device connected to a network 136 may communicate voice, video, or data over the network 136. Further, the instructions 112 may be transmitted or received over the network 136 via the network interface device or wireless interface adapter 128. It is appreciated that any computing device including the cloud orchestrator server 158, the cloud orchestrator console 160, and the anchor information handling system node 100 may include a computer-readable medium that includes instructions, parameters, and profiles 112.

The anchor information handling system node 100 may include a set of instructions 112 that may be executed to cause the computer system to perform any one or more of the methods or computer-based functions disclosed herein. For example, instructions 112 may be executed by a hardware processor 102, GPU 103, EC 104 or any other hardware processing resource and may include software agents, or other aspects or components used to execute the methods and systems described herein. Various software modules comprising application instructions 112 may be coordinated by an OS 116, and/or via an application programming interface (API). An example OS 116 may include Windows®, Android®, and other OS types. Example APIs may include Win 32, Core Java API, or Android APIs.

In an embodiment, the anchor information handling system node 100 may include a disk drive unit 120. The disk drive unit 120 and may include machine-readable code instructions, parameters, and profiles 112 in which one or more sets of machine-readable code instructions, parameters, and profiles 112 such as firmware or software can be embedded to be executed by the hardware processor 102 or other hardware processing devices such as a GPU 103 or EC 104, or other microcontroller unit to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 103 of anchor information handling system node 100.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the anchor information handling system node 100 may further include a power management unit (PMU) 122 (a.k.a. a power supply unit (PSU)). The PMU 122 may include a hardware controller and executable machine-readable code instructions to manage the power provided to the components of the anchor information handling system node 100 such as the hardware processor 102 and other hardware components described herein. The PMU 122 may control power to one or more components including the one or more drive units 120, the hardware processor 102 (e.g., CPU), the EC 104, the GPU 103, a video/graphic display device 144, or other wired I/O devices 142 such as the mouse 152, the stylus 148, a keyboard 146, and a trackpad 150 and other components that may require power when a power button has been actuated by a user. In an embodiment, the PMU 122 may monitor power levels and be electrically coupled to the anchor information handling system node 100 to provide this power. The PMU 122 may be coupled to the bus 118 to provide or receive data or machine-readable code instructions. The PMU 122 may regulate power from a power source such as the battery 124 or AC power adapter 126. In an embodiment, the battery 124 may be charged via the AC power adapter 126 and provide power to the components of the anchor information handling system node 100, via wired connections as applicable, or when AC power from the AC power adapter 126 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the anchor information handling system node 100 is operatively coupled to a peripheral device workspace cloud orchestrator 156 that includes one or more software modules executing at any number of servers, computing devices, and other cloud computing resources such as the peripheral device workspace cloud orchestrator server 158. The peripheral device workspace cloud orchestrator 156 may, therefore, include any software or firmware executing on hardware that may be distributed over multiple physical locations but act in concert with each other and specifically the peripheral device workspace cloud orchestrator server 158 to facilitate the attestation and authorization of a newly introduced peripheral device node into a peripheral device workspace that includes the anchor information handling system node 100. The peripheral device workspace cloud orchestrator 156 and peripheral device workspace cloud orchestrator server 158 may also facilitate an ITDM to, via hardware device operational policies, create the peripheral device workspace with the one or more peripheral device nodes (e.g., including the anchor information handling system node 100 as an anchor device node) forming part of the peripheral device workspace after receiving device enrollment data describing one or more peripheral device nodes. The execution of the computer-readable program code of the peripheral device workspace cloud manageability orchestrator module 168 may also allow the ITDM to create hardware device operational policies at the peripheral device workspace cloud orchestrator console 160 based on the registered peripheral device nodes detected within the one or more created peripheral device workspaces and apply the hardware device operational policies to the created peripheral device workspace. It is appreciated that the peripheral device nodes described herein may include each of the peripheral devices operatively coupled to the anchor information handling system node 100 acting as a primary or anchor device node and the workspaces created may be described as a peripheral device workspace.

The peripheral device workspace cloud orchestrator server 158 may be any computing device that may include similar elements as the anchor information handling system node 100 such as a memory device, a cloud orchestrator hardware processing device 166, a PMU, and other elements that allow the peripheral device workspace cloud orchestrator server 158 to execute code instructions of the cloud manageability orchestrator module 166 and ecosystem manageability service module 168 and other software as described herein. In an embodiment, the peripheral device workspace cloud orchestrator server 158 may be operatively coupled to an information handling system presenting a peripheral device workspace cloud orchestrator console 160 graphical user interface via a network connection, for example, as described herein. The peripheral device workspace cloud orchestrator console 160 graphical user interface may be used by the ITDM to create and propagate hardware device operational policies, track a lifecycle of ordered peripheral device nodes, monitor for compliant and non-compliant peripheral device nodes within a peripheral device workspace, propagate optimal settings for any given peripheral device node or types of peripheral device nodes, monitor and provide recommended software/firmware updates to peripheral device nodes, remediate software/firmware issues among the plurality of peripheral device nodes, manage dynamic peripheral device workspace sessions (e.g., associate a user's identification with a peripheral device workspace), enable automatic security updates for peripheral device nodes within the peripheral device workspace, mange auto-pairing of peripheral device nodes to other peripheral device nodes within the peripheral device workspace, and troubleshoot and remediate node deceives from the cloud orchestrator console 160 graphical user interface. It is appreciated that the peripheral device workspace cloud orchestrator console 160 graphical user interface may be interacted with using a cloud orchestrator input device 162 and a cloud orchestrator video display device 164 that allows the ITDM to complete these processes and engage with the peripheral device workspace cloud orchestrator server 158 in an embodiment.

As described herein, the peripheral device workspace cloud orchestrator server 158 includes a computer-readable program code of a peripheral device workspace cloud manageability orchestrator module 168 that, when executed by cloud orchestrator hardware processing device 166 of the peripheral device workspace cloud orchestrator server 158, receives device enrollment data describing one or more peripheral device nodes and creates a peripheral device workspace with the one or more peripheral device nodes forming part of the peripheral device workspace. In the context of the present specification and in the appended claims, a peripheral device workspace may be an ecosystem of peripheral device nodes (e.g., including peripheral devices coupled to the anchor information handling system node 100, a docking station 151, etc.) connected to a primary or anchor node device node such as the anchor information handling system node 100. In an embodiment, a peripheral device workspace may also be associated with a peripheral device workspace identification value and part of a user composite peripheral device workspace identifier having a location and a manifest of each of the anchor information handling system node 100, peripheral device nodes (e.g., input/output devices 142) and other nodes (e.g., smart docking station 151). In an embodiment, a user may have multiple peripheral device workspaces having peripheral device workspace identification values associated with the user based on the context and/or environment of each identified peripheral device workspace. For example, a user composite peripheral device workspace identifier may be used to define a first peripheral device workspace at a home office having a first peripheral device workspace identification value, a second peripheral device workspace at a work office having a second peripheral device workspace identification value, a third peripheral device workspace at a different location (e.g., a coffee shop) having a third peripheral device workspace identification value, and other peripheral device workspaces that can be defined by both the peripheral device nodes included within the peripheral device workspace and the location of the peripheral device workspace (e.g., defined by location data such as GPS data or network data) and having a having a peripheral device workspace identification value. In an embodiment, the manifest of peripheral device nodes and the anchor information handling system node 100 within any given peripheral device workspace, the peripheral device workspace identification value, and the user composite peripheral device workspace identifier may be stored on a peripheral device workspace database 176 operatively coupled to the peripheral device workspace cloud orchestrator server 158.

In an embodiment, the execution of computer-readable program code of the peripheral device workspace cloud manageability orchestrator module 166 causes the peripheral device workspace cloud orchestrator server 158 to receive hardware device operational policies based on the registered peripheral device nodes detected within the one or more created peripheral device workspaces having peripheral device workspace identification values. In an embodiment, the hardware device operational policies are received from the peripheral device workspace cloud orchestrator console 160 graphical user interface as initiated by the ITDM. The ITDM may be any internet technology decision maker that may decide the hardware device operational policies to be associated with peripheral device workspaces formed at the peripheral device workspace cloud orchestrator server 158 and having peripheral device workspace identification values. For example, the ITDM may decide that certain types of peripheral device nodes are not allowed to be operatively coupled to a primary or anchor node device node due to potential security issues associated with those types of device nodes. In another example, the ITDM may be any internet technology decision maker that may decide which settings for each of the peripheral device nodes, including the primary or anchor node device node, is an optimal and desired setting to be used. In yet another example, the ITDM may set a policy in which certain peripheral device nodes are restricted or not permitted in a particular peripheral device workspace due to security risks or operational issues such as incompatibility or licensing. In an embodiment, the ITDM may create these hardware device operational policies and desired settings at the peripheral device workspace cloud orchestrator console 160 graphical user interface which propagates these hardware device operational policies to the peripheral device workspace cloud orchestrator server 158 executing the peripheral device workspace cloud manageability orchestrator module 168. Upon receipt of these hardware device operational policies created at the peripheral device workspace cloud orchestrator console 160 graphical user interface, the execution of the peripheral device workspace cloud manageability orchestrator module 168 may propagate these hardware device operational policies, via the peripheral device server notification gateway 174 and the anchor information handling system node 100, to each of the device nodes within the created peripheral device workspace thereby eliminating the need for the ITDM to manually address each device node to propagate these hardware device operational policies.

In an embodiment, the cloud orchestrator hardware processing device 166 of the peripheral device workspace cloud orchestrator server 158 may also execute computer readable program code of a peripheral device node attestation service module 170. Execution of the peripheral device node attestation service module 170 may attest whether an introduced peripheral device node is a trusted node based on the received peripheral device enrollment data. As described herein, a network interface device of the peripheral device workspace cloud orchestrator server 158 receives detected peripheral device enrollment data that describes an introduced peripheral device node that has requested to be operatively coupled to an anchor information handling system node within a peripheral device workspace. Again, the anchor information handling system node is operatively coupled to the peripheral device workspace cloud orchestrator server and identified as being included within the peripheral device workspace pursuant to the execution of the peripheral device workspace cloud manageability orchestrator module 168 as described herein. In an embodiment, the attestation of the introduced peripheral device node may include the peripheral device node attestation service module 170 accessing the data stored on a trusted node database 178 that contains a listing of peripheral devices that have and have been listed as trusted peripheral device nodes and have been listed as untrusted peripheral device nodes for security reasons, operational or licensing compatibility reasons, or other reasons.

In an embodiment, because the peripheral device workspace cloud orchestrator server 158 has received peripheral device enrollment data related to the introduced peripheral device node, the execution of the peripheral device node attestation service module 170 causes the peripheral device workspace cloud orchestrator server 158 to compare the peripheral device enrollment data to the data stored on the trusted node database 178. In an embodiment, the trusted node database 178 may not contain data descriptive of the same or similar introduced peripheral device node and, therefore, the peripheral device workspace cloud orchestrator server 158 cannot attest to the trustworthiness of the introduced peripheral device node. In this embodiment, the peripheral device workspace cloud orchestrator server 158 may be provided with access to a third-party database (not shown) that is operated by the manufacturer of the introduced peripheral device node that allows the peripheral device workspace cloud orchestrator server 158 to make the attestation as described herein. In another embodiment, the trusted node database 178 may include data describing the same or similar peripheral device as that of the introduced peripheral device node seeking to be operatively coupled to the anchor information handling system node 100. In this example, the comparison of the peripheral device enrollment data associated with the introduced peripheral device node may result in the introduced peripheral device node being on an untrusted list of peripheral devices. In this example embodiment, the peripheral device workspace cloud orchestrator server 158 may send a notification to the anchor information handling system node 100 indicating the that introduced peripheral device node is an untrusted peripheral device node and should not be operatively coupled to the anchor information handling system node 100 and included within the peripheral device workspace. In another embodiment, the comparison of the peripheral device enrollment data associated with the introduced peripheral device node may result in the introduced peripheral device node being on a trusted list of peripheral devices. In this example embodiment, the peripheral device workspace cloud orchestrator server 158 may send a notification to the anchor information handling system node 100 indicating the that introduced peripheral device node is a trusted peripheral device node and is allowed to be operatively coupled to the anchor information handling system node 100 and included within the peripheral device workspace.

In an embodiment, the notification of the trustworthiness of the introduced peripheral device node by the peripheral device workspace cloud orchestrator server 158 may be accompanied with operational entitlements that define the actions allowed by the introduced peripheral device node. In an embodiment, in order to provide these operational entitlements, the cloud orchestrator hardware processing device 166 may execute computer-readable program code of a peripheral device node authorization service module 172 that generates the operational entitlements that define the actions allowed by the introduced peripheral device node. It is appreciated that, although the introduced peripheral device node may be listed as a trustworthy peripheral device, the data stored on the trusted node database 178 may be modified pursuant to one or more hardware device operational policies created by the ITDM via the peripheral device workspace cloud orchestrator console 160 graphical user interface and stored on the policy database 180. For example, a universal serial bus (USB) flash drive may be an example of an introduced peripheral device node that is listed on the trusted node database 178 as a trusted peripheral device. However, in order to increase security at an enterprise, the ITDM may have created a hardware device operational policy that mandates that such USB flash drives be limited to read-only status and not be allowed to be written to or to write to a data storage device on the anchor information handling system node 100. This hardware device operational policy may affect the notice sent from the peripheral device workspace cloud orchestrator server 158 to the anchor information handling system node 100 such that the notification indicates to the anchor information handling system node 100 (and possibly the user via a graphical user interface (GUI)) that the operation of the USB flash drive is limited to read-only status or write-only status. This may limit the ability of potentially dangerous malware or computer viruses to be loaded onto the anchor information handling system node 100 or confidential or proprietary data from being downloaded from the anchor information handling system node 100 depending on the hardware device operational policies created by the ITDM at the peripheral device workspace cloud orchestrator console 160.

Thus, the execution of the peripheral device node authorization service module 172 takes into consideration those hardware device operational policies stored on the policy database 180 prior to sending the authorization notification to the anchor information handling system node 100. Where certain functionalities of the introduced peripheral device node are limited, the ITDM may be so notified via the cloud orchestrator video display device 164 of the peripheral device workspace cloud orchestrator console 160 graphical use interface of this limitation on the user's ability to take advantage of all the functionalities of the introduced peripheral device node. In an embodiment, the ITDM may review these limitations and, via use of the cloud orchestrator input device 162, alter or otherwise override the limitations on the functionalities of the introduced peripheral device node for the user either permanently or for a limited amount of time. This updated hardware device operational policy may be tied to the specific introduced peripheral device node at the specific peripheral device workspace where the user's anchor information handling system node 100 is operating such that an exception is made pursuant to the ITDM's customized policy. As such, the operational entitlements associated with the introduced peripheral device node may be altered by the ITDM and stored, by the peripheral device workspace cloud orchestrator server 158, on the peripheral device workspace database 176 for later review by the peripheral device workspace cloud orchestrator server 158 if and when the introduced peripheral device node is again operatively coupled to the anchor information handling system node 100.

In an embodiment, the anchor information handling system node 100 may be capable of completing the attestation and authorization processes conducted by the peripheral device workspace cloud orchestrator server 158 without the anchor information handling system node 100 being operatively coupled to the peripheral device workspace cloud orchestrator server 158. In this example embodiment, the anchor information handling system node 100 may rely on data maintained on other user's anchor information handling system node 100 that are included within other peripheral device workspaces. In an example embodiment, the anchor information handling system node 100 may be operatively coupled to another user's anchor information handling system node 100 via a network connection such that device enrollment data associated with the other user's anchor information handling system node 100 and associated peripheral device nodes is accessible to the user's anchor information handling system node 100. Having access to this device enrollment data, the anchor information handling system node 100 may execute computer-readable program code of a peripheral device node attestation sub-agent 182 and a peripheral device node authorization sub-agent 184 to complete the tasks similar to those executed by the operation of the peripheral device node attestation service module 170 and peripheral device node authorization service module 172 as described herein. In an example embodiment, the anchor information handling system nodes 100 associated with other users' peripheral device workspaces within an enterprise may advertise or broadcast the peripheral device enrollment data as a manifest of peripheral devices currently operatively coupled with their respective anchor information handling system nodes 100. The anchor information handling system node 100 may access these broadcasts and determine whether the peripheral device enrollment data associated with the introduced peripheral device node matches the device enrollment data associated with any of the peripheral devices currently operatively coupled to each of the other anchor information handling system nodes 100 at these other peripheral device workspaces. Where a match is not present, the hardware processor 102 of the anchor information handling system node 100 may deny access of the introduced peripheral device node to the anchor information handling system node 100 and prevent or limit the functionalities of the introduced peripheral device node. Where a match is found, however, the introduced peripheral device node may be onboarded into the peripheral device workspace and operatively coupled to the anchor information handling system node 100. In an embodiment, the user's anchor information handling system node 100 may execute computer-readable program code of peripheral device node attestation sub-agent 182 that receives peripheral device workspace data related to other anchor information handling system nodes via a peer discovery mechanism. These peer discovery mechanisms may include, for example, multicast DNS-based (mDNS-based) peer discovery clusters on a local area network (LAN), link layer discovery protocols (LLDPs), layer 2 neighbor discovery protocols, universal plug and play (UPnP) protocols, network basic input/output system (NetBIOS) and protocol, zero-configuration networking (ZeroConf) protocols, and the like. These types of protocols allow the user's anchor information handling system node 100 to request or receive the broadcasted peripheral device workspace data related to other users' peripheral device workspaces that may include a similar type, make, or model, as the introduced peripheral device node the user is attempting to operatively couple to the anchor information handling system node 100.

In an embodiment, the hardware processor 102 of the anchor information handling system node 100 may execute computer-readable program code of a peripheral device node authorization sub-agent 184 to provide operational entitlements for each onboarded introduced peripheral device node. Again, because the anchor information handling system node 100 is not operatively coupled to the peripheral device workspace cloud orchestrator server 158, the peripheral device enrollment data and, specifically, corresponding operational entitlements of other peripheral device nodes within other users' peripheral device workspaces may be used by the peripheral device node authorization sub-agent 184 to determine the operational entitlements for the introduced peripheral device node as well. Alternatively, a very limited set of operational entitlements may be implemented for the introduced peripheral device node in other embodiments until network access to the operation of the peripheral device node attestation service module 170 and peripheral device node authorization service module 172 at the peripheral device workspace cloud orchestrator server 158 is available for full attestation.

After reviewing the operational entitlements associated with these other peripheral devices within the other peripheral device workspaces, the peripheral device node authorization sub-agent 184 may onboard the introduced peripheral device node, prevent onboarding of the introduced peripheral device node due to lack of identifiable operational entitlements, or onboard the introduced peripheral device node into the user's peripheral device workspace with limitations to the functionalities of the introduced peripheral device node. When the user's anchor information handling system node 100 is once again operatively coupled to the peripheral device workspace cloud orchestrator server 158, the execution of the peripheral device node attestation service module 170 and peripheral device node authorization service module 172 as described herein may again take place in order to confirm the onboarding or notify the ITDM, via the cloud orchestrator video display device 164 of the peripheral device workspace cloud orchestrator console 160 graphical user interface, of the limited functionalities of the introduced peripheral device node.

In an embodiment, the introduced peripheral device node may be an introduced smart peripheral device node. An introduced smart peripheral device node may be an introduced peripheral device node that includes, at least, networking capabilities that allow the introduced smart peripheral device node to access the peripheral device workspace cloud orchestrator server 158 itself. In an example embodiment, the anchor information handling system node 100 may not have access to the peripheral device workspace cloud orchestrator server 158 via the network 136 and the introduced smart peripheral device node may act on its own behalf in order to onboard the introduced smart peripheral device node into the peripheral device workspace and operatively couple the introduced smart peripheral device node to the anchor information handling system node 100. In an embodiment, the introduced smart peripheral device node may communicate peripheral device enrollment data associated with the introduced smart peripheral device node to the peripheral device workspace cloud orchestrator server 158 for the peripheral device workspace cloud orchestrator server 158 to execute the peripheral device node attestation service module 170 as described herein. Where the comparison of the peripheral device enrollment data matches details of trusted peripheral devices stored in the trusted node database 178, the cloud orchestrator hardware processing device 166 of the peripheral device workspace cloud orchestrator server 158 may execute the computer-readable code of the peripheral device node authorization service module 172 to determine what operational entitlements the introduced smart peripheral device node is to be awarded. In an example embodiment, the operational entitlements may be associated with a secure token and sent to the introduced smart peripheral device node. At this point, the introduced smart peripheral device node may provide the operational entitlements and secure token to the hardware processor 102 of the anchor information handling system node 100 such that the anchor information handling system node 100 can verify that the introduced smart peripheral device node has been attested and authorized to be operatively coupled to the anchor information handling system node 100.

The systems and methods described herein, therefore, allows for secure onboarding of an introduced peripheral device node into a peripheral device workspace of which the user's anchor information handling system node is included. The systems and methods described herein also limits access to the introduced peripheral device node attempting to be onboarded onto the anchor information handling system node and within the peripheral device workspace prior to authorization to be included into the peripheral device workspace from the peripheral device workspace cloud orchestrator server. This is done so that there is no security issues that may arise during the operative coupling of the introduced peripheral device node to the anchor information handling system node. Still further, the systems and methods described herein allow for such processes whether the anchor information handling system node is online or offline relative to the peripheral device workspace cloud orchestrator server thereby allowing the user to operatively couple the introduced peripheral device node to the anchor information handling system node regardless of network status.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

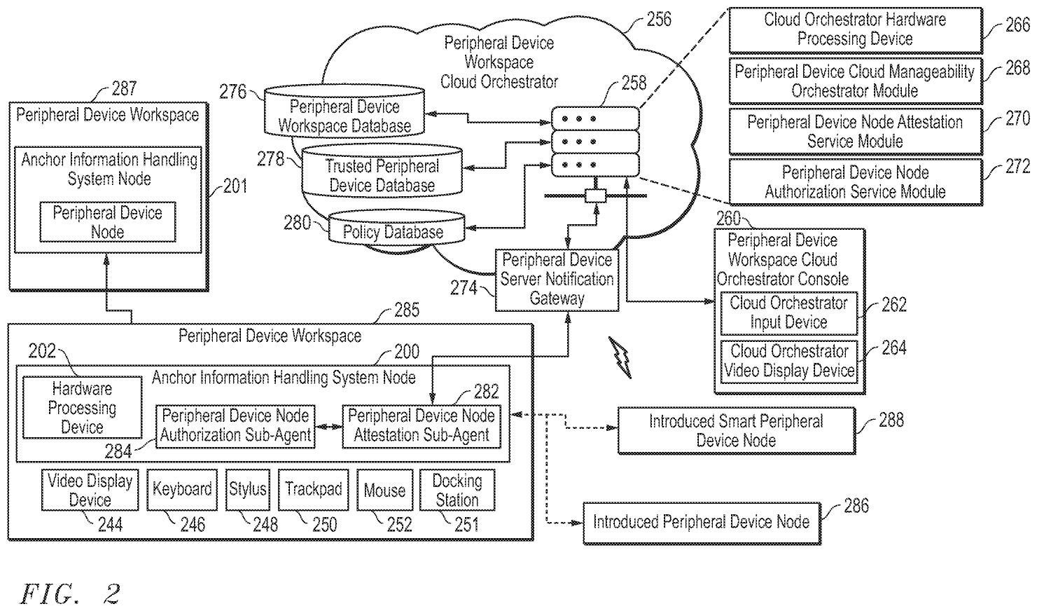

FIG. 2 is a block diagram illustrating an anchor information handling system node 200 of a peripheral device workspace 285 operatively coupled to a remotely located peripheral device workspace cloud orchestrator server 258 executing one or more software or firmware modules a peripheral device workspace cloud orchestrator 256 according to another embodiment of the present disclosure. As described herein, the anchor information handling system node 200 may be a primary or anchor node within a peripheral device workspace 285 that includes any number of peripheral device nodes. For example, the anchor information handling system node 200 may be operatively coupled to a video display device 244, a keyboard 246, a stylus 248, a trackpad 250, a mouse 252, and a docking station 251. It is appreciated that the peripheral device workspace 285 may include some or all of the peripheral device nodes shown in FIG. 2 and the peripheral devices shown in FIG. 2 are merely examples and any type of peripheral device nodes are contemplated in the peripheral device workspace 285.

It is appreciated that, during use of the anchor information handling system node 200, the user may wish to operatively couple additional peripheral devices to the anchor information handling system node 200 in order to increase the functionality of the anchor information handling system node 200 within the peripheral device workspace 285. For example, a gaming headset (e.g., introduced peripheral device node 286) or a virtual reality headset (e.g., introduced smart peripheral device node 288) may be added within the peripheral device workspace 285 so that the user may engage further with the anchor information handling system node 200 using the input and output capabilities and functionalities of these types of devices or any type of additional peripheral device workspace. FIG. 2 shows that an introduced peripheral device node 286 (e.g., a gaming headset) and an introduced smart peripheral device node 288 (e.g., a virtual reality headset) may be introduced into the peripheral device workspace 285 when the user attempts to operatively couple these peripheral devices to the anchor information handling system node 200. The systems and methods described herein allow for the attestation and authorization of these peripheral devices for security purposes of an enterprise prior to the introduced peripheral device node 286 and/or introduced smart peripheral device node 288 being operatively coupled to the anchor information handling system node 200 and included as a device node within the peripheral device workspace 285.

As described herein, in order to attest the trustworthiness of the introduced peripheral device node 286 and/or introduced smart peripheral device node 288, the anchor information handling system node 200 may be operatively coupled to a peripheral device workspace cloud orchestrator server 258 executing one or more software or firmware modules of a peripheral device workspace cloud orchestrator 256. In an embodiment, the peripheral device workspace cloud orchestrator server 258 may receive detected peripheral device enrollment data from the execution of code instructions of the peripheral device node authorization sub-agent 284 or the peripheral device node attestation sub-agent 282 at the anchor information handling system node 200 that describes the introduced smart peripheral device node 288 and/or introduced peripheral device node 286. This detected peripheral device enrollment data may include device identification data such as a make, model, manufacturer, and serial number along with any other identification information that allows the peripheral device workspace cloud orchestrator server 258 to identify the introduced peripheral device node 286 and introduced smart peripheral device node 288.

In an embodiment, the cloud orchestrator hardware processing device 266 of the peripheral device workspace cloud orchestrator server 258 executes computer-readable program code of the node attestation service module 270. Execution of the peripheral device node attestation service module 270 may cause the peripheral device workspace cloud orchestrator server 258 to attest whether either of the introduced peripheral device node 286 or introduced smart peripheral device node 288 are trusted nodes based on the received peripheral device enrollment data. As described herein, a network interface device of the peripheral device workspace cloud orchestrator server 258 receives detected peripheral device enrollment data that from the peripheral device node authorization sub-agent 284 or the peripheral device node attestation sub-agent 282 that describes the introduced peripheral device node 286 and/or introduced smart peripheral device node 288 that has requested to be operatively coupled to the anchor information handling system node 200 within a peripheral device workspace 285. Again, the anchor information handling system node 200 is operatively coupled to the peripheral device workspace cloud orchestrator server 258 and identified as being included within the peripheral device workspace 285 pursuant to the execution of the peripheral device workspace cloud manageability orchestrator module 268 as described herein.

In an embodiment, the attestation of the introduced peripheral device node 286 and/or introduced smart peripheral device node 288 may include the peripheral device node attestation service module 270 accessing the data stored on a trusted node database 278 that contains a listing of peripheral devices and smart peripheral devices that have been listed as trusted peripheral device nodes or have been listed as untrusted peripheral device nodes. In an embodiment, because the peripheral device workspace cloud orchestrator server 258 has received peripheral device enrollment data related to the introduced peripheral device node 286 and introduced smart peripheral device node 288, the execution of the peripheral device node attestation service module 270 causes the peripheral device workspace cloud orchestrator server 258 to compare these sets of peripheral device enrollment data to the data stored on the trusted node database 278.

In an embodiment, the trusted node database 278 may not contain data descriptive of the same or similar introduced peripheral device node 286 and/or introduced smart peripheral device node 288 and, therefore, the peripheral device workspace cloud orchestrator server 258 cannot attest to the trustworthiness of the introduced peripheral device node. In this embodiment, the peripheral device workspace cloud orchestrator server 258 may be provided with access to a third-party database (not shown) that is operated by the manufacturer of the introduced peripheral device node 286 and/or introduced smart peripheral device node 288 that allows the peripheral device workspace cloud orchestrator server 258 to determine the peripheral device and its capabilities and make the attestation as described herein.

In another embodiment, the trusted node database 278 may include data describing the same or similar peripheral device as that of the introduced peripheral device node 286 and/or introduced smart peripheral device node 288 seeking to be operatively coupled to the anchor information handling system node 200. In this example, the comparison of the peripheral device enrollment data associated with the introduced peripheral device node 286 and/or introduced smart peripheral device node 288 may result in the introduced peripheral device node 286 and/or introduced smart peripheral device node 288 being on an untrusted list of peripheral devices. In this example embodiment, the peripheral device workspace cloud orchestrator server 258 may send a notification to the anchor information handling system node 200 indicating the that introduced peripheral device node 286 and/or introduced smart peripheral device node 288 are listed as untrusted peripheral device nodes and should not be operatively coupled to the anchor information handling system node 200 and included within the peripheral device workspace 285. In another embodiment, the comparison of the peripheral device enrollment data associated with the introduced peripheral device node 286 and/or introduced smart peripheral device node 288 may result in the introduced peripheral device node 286 and/or introduced smart peripheral device node 288 being on a trusted list of peripheral devices. In this example embodiment, the peripheral device workspace cloud orchestrator server 258 may send a notification to the anchor information handling system node 200 indicating the that introduced peripheral device node 286 and/or introduced smart peripheral device node 288 are trusted peripheral device nodes and are allowed to be operatively coupled to the anchor information handling system node 200 and included within the peripheral device workspace 285.

In an embodiment, the notification of the trustworthiness of the introduced peripheral device node 286 and/or introduced smart peripheral device node 288 by the peripheral device workspace cloud orchestrator server 258 may be accompanied with operational entitlements that define the actions allowed by the introduced peripheral device node 286 and/or introduced smart peripheral device node 288. In an embodiment, in order to provide these operational entitlements, the cloud orchestrator hardware processing device 266 may execute computer-readable program code of a peripheral device node authorization service module 272 that generates the operational entitlements that define the actions allowed by the introduced peripheral device node 286 and/or introduced smart peripheral device node 288. These may depend in part on the capabilities determined for the introduced peripheral device 286, 288 and the security requirements or operational policies in place at a peripheral device workspace 285. These operational entitlements may then be transmitted for implementation and execution at the peripheral device node authorization sub-agent 284 or the peripheral device node attestation sub-agent 282 at the anchor information handling system 200.

It is appreciated that, although the introduced peripheral device node 286 and/or introduced smart peripheral device node 288 may be listed as a trustworthy peripheral device, the data stored on the trusted node database 278 may be modified pursuant to one or more hardware device operational policies created by the ITDM via the peripheral device workspace cloud orchestrator console 260 graphical user interface and stored on the policy database 280. For example, a universal serial bus (USB) flash drive may be an example of an introduced peripheral device node that is listed on the trusted node database 278 as a trusted peripheral device. However, in order to increase security at an enterprise, the ITDM may have created a hardware device operational policy that mandates that such USB flash drives be limited to read-only status and not be allowed to be written to or allow a write to a data storage device on the anchor information handling system node 200 or in the peripheral device workspace 285. In another embodiment, such a USB flash drive may be limited to write only to prevent any outside files from being downloaded to node devices at peripheral device workspace 285. This hardware device operational policy may affect the notice sent from the peripheral device workspace cloud orchestrator server 258 to the anchor information handling system node 200 such that the notification indicates to the anchor information handling system node 200 (and possibly the user via another graphical user interface (GUI)) that the operation of the USB flash drive is limited to read-only status or write-only status. This may limit the ability of potentially dangerous malware or computer viruses to be loaded onto the anchor information handling system node 200 or confidential or proprietary data from being downloaded from the anchor information handling system node 200 depending on the hardware device operational policies created by the ITDM at the peripheral device workspace cloud orchestrator console 260. Thus, the execution of the peripheral device node authorization service module 272 takes into consideration those hardware device operational policies stored on the policy database 280 prior to sending the authorization notification to the anchor information handling system node 200.

Where certain functionalities of the introduced peripheral device node 286 and/or introduced smart peripheral device node 288 are limited, the ITDM may be so notified via the cloud orchestrator video display device 264 of the peripheral device workspace cloud orchestrator console 260 graphical user interface of this limitation on the user's ability to take advantage of all the functionalities of the introduced peripheral device node 286 and/or introduced smart peripheral device node 288. In an embodiment, the ITDM may review these limitations and, via use of the cloud orchestrator input device 262, alter or otherwise override the limitations on the functionalities of the introduced peripheral device node 286 and/or introduced smart peripheral device node 288 for the user either permanently or for a limited amount of time. This updated hardware device operational policy may be tied to the specific introduced peripheral device node 286 and/or introduced smart peripheral device node 288 at the specific peripheral device workspace 285 where the user's anchor information handling system node 200 is operating such that an exception is made pursuant to the ITDM's customized policy. As such, the operational entitlements associated with the introduced peripheral device node 286 and/or introduced smart peripheral device node 288 may be altered by the ITDM and stored, by the peripheral device workspace cloud orchestrator server 258, on the peripheral device workspace database 276 for later review by the peripheral device workspace cloud orchestrator server 258 if and when the introduced peripheral device node 286 and/or introduced smart peripheral device node 288 are again operatively coupled to the anchor information handling system node 200.

In an embodiment, the anchor information handling system node 200 may be capable of completing the attestation and authorization processes conducted by the peripheral device workspace cloud orchestrator server 258 without the anchor information handling system node 200 being operatively coupled to the peripheral device workspace cloud orchestrator server 258. In this example embodiment, the anchor information handling system node 200 may rely on data maintained on one or more other user's anchor information handling system nodes 201 that are included within other peripheral device workspaces 287. These other peripheral device workspaces 285, like 284 in FIG. 2, and may be located elsewhere in the enterprise such as on a similar floor, in a same building, or anywhere in the enterprise that is monitored by the peripheral device workspace cloud orchestrator server or servers 258. In an example embodiment, the anchor information handling system node 200 may be operatively coupled to another user's anchor information handling system node 201 via a network connection such that device enrollment data associated with the other user's anchor information handling system node 201 and associated peripheral device nodes (not shown) is accessible to the user's anchor information handling system node 200. Having access to this device enrollment data, the anchor information handling system node 200 may execute computer-readable program code of a peripheral device node attestation sub-agent 282 and a peripheral device node authorization sub-agent 284 to complete the tasks similar to those executed by the operation of the peripheral device node attestation service module 270 and peripheral device node authorization service module 272 as described herein.

In an example embodiment, the anchor information handling system nodes 201 associated with other users' peripheral device workspaces 287 may advertise or broadcast the peripheral device enrollment data as a manifest of peripheral devices currently operatively coupled with their respective anchor information handling system nodes 201. The anchor information handling system node 200 may access these broadcasts and determine whether the peripheral device enrollment data associated with the introduced peripheral device node matches the device enrollment data associated with any of the peripheral devices currently operatively coupled to each of the other anchor information handling system nodes 201 at these other peripheral device workspaces 287. Where a match is not present, the hardware processor 202 of the anchor information handling system node 200 may deny access of the introduced peripheral device node 286 and/or introduced smart peripheral device node 288 to the anchor information handling system node 200 and prevent or limit the functionalities of the introduced peripheral device node 286 and/or introduced smart peripheral device node 288. Where a match is found, however, the introduced peripheral device node 286 and/or introduced smart peripheral device node 288 may be onboarded into the peripheral device workspace 285 and operatively coupled to the anchor information handling system node 200. In an embodiment, the user's anchor information handling system node 200 may execute computer-readable program code of peripheral device node attestation sub-agent 282 that receives peripheral device workspace data related to other anchor information handling system nodes 201 via a peer discovery mechanism. These peer discovery mechanisms may include, for example, multicast DNS-based (mDNS-based) peer discovery clusters on a local area network (LAN), link layer discovery protocols (LLDPs), layer 2 neighbor discovery protocols, universal plug and play (UPnP) protocols, network basic input/output system (NetBIOS) and protocol, zero-configuration networking (ZeroConf) protocols, and the like. These types of protocols allow the user's anchor information handling system node 200 to request or receive the broadcasted peripheral device workspace data related to other users' peripheral device workspaces 287 that may include a similar type, make, or model, as the introduced peripheral device node 286 and/or introduced smart peripheral device node 288 the user is attempting to operatively couple to the anchor information handling system node 200.

In an embodiment, the hardware processor 202 of the anchor information handling system node 200 may execute computer-readable program code of a peripheral device node authorization sub-agent 284 to provide operational entitlements for each onboarded introduced peripheral device node 286 and/or introduced smart peripheral device node 288. Again, because the anchor information handling system node 200 is not operatively coupled to the peripheral device workspace cloud orchestrator server 258, the peripheral device enrollment data and, specifically, corresponding operational entitlements of other peripheral device nodes within other users' peripheral device workspaces may be used by the peripheral device node authorization sub-agent 284 to determine the operational entitlements for the introduced peripheral device node 286 and/or introduced smart peripheral device node 288 as well. After reviewing the operational entitlements associated with these other peripheral devices within the other peripheral device workspaces 287, the peripheral device node authorization sub-agent 284 may onboard the introduced peripheral device node 286 and/or introduced smart peripheral device node 288 with similar operational entitlements applied. In other embodiments, a default level of operational entitlements may be applied to an introduced peripheral device node 286, 288 when attestation via another peripheral device workspace 287 is used rather than attestation and authorization from the peripheral device node attestation service module 270 and peripheral device node authorization service module 272. These default operational entitlements may limit operation of the introduced peripheral device nodes 286, 288 for security temporarily until the anchor information handling system may have network access to the peripheral device workspace cloud orchestrator again in some embodiments.

Thus, the peripheral device node authorization sub-agent 284 prevent onboarding of the introduced peripheral device node 286 and/or introduced smart peripheral device node 288, or onboard the introduced peripheral device node 286 and/or introduced smart peripheral device node 288 into the user's peripheral device workspace 284 with limitations to the functionalities of the introduced peripheral device node 286 and/or introduced smart peripheral device node 288. When the user's anchor information handling system node 200 is once again operatively coupled to the peripheral device workspace cloud orchestrator server 258, the execution of the peripheral device node attestation service module 270 and peripheral device node authorization service module 272 as described herein may again take place in order to confirm the onboarding or notify the ITDM, via the cloud orchestrator video display device 264 of the peripheral device workspace cloud orchestrator console 260, of the limited functionalities of the introduced peripheral device node 286 and/or introduced smart peripheral device node 288.

In an embodiment, the introduced peripheral device node may be an introduced smart peripheral device node 288. An introduced smart peripheral device node 288 may be an introduced peripheral device node that includes, at least, networking capabilities that allow the introduced smart peripheral device node 288 to access the peripheral device workspace cloud orchestrator server 258 itself. In an example embodiment, the anchor information handling system node 200 may not have access to the peripheral device workspace cloud orchestrator server 258 via the network 236 and the introduced smart peripheral device node 288 may act as a go-between from the anchor information handling system node 200 and the peripheral device workspace cloud orchestrator server 258 in order to onboard the introduced smart peripheral device node 288 into the peripheral device workspace 285 and operatively couple the introduced smart peripheral device node 288 to the anchor information handling system node 200. In an embodiment, the introduced smart peripheral device node 288 may communicate peripheral device enrollment data associated with the introduced smart peripheral device node 288 to the peripheral device workspace cloud orchestrator server 258 for the peripheral device workspace cloud orchestrator server 258 to execute the peripheral device node attestation service module 270 as described herein. Where the comparison of the peripheral device enrollment data matches details of trusted peripheral devices stored in the trusted node database 278, the cloud orchestrator hardware processing device 266 of the peripheral device workspace cloud orchestrator server 258 may execute the computer-readable code of the peripheral device node authorization service module 272 to determine what operational entitlements the introduced smart peripheral device node 288 is to be awarded. In an example embodiment, the operational entitlements may be associated with a secure token and sent to the introduced smart peripheral device node 288. At this point, the introduced smart peripheral device node 288 may provide the operational entitlements and secure token to the hardware processor 202 of the anchor information handling system node 200 such that the anchor information handling system node 200 can verify that the introduced smart peripheral device node 288 has been attested and authorized to be operatively coupled to the anchor information handling system node 200.

The systems and methods described herein, therefore, allows for secure onboarding of an introduced peripheral device node 286 and/or introduced smart peripheral device node 288 into a peripheral device workspace 285 of which the user's anchor information handling system node 200 is included. The systems and methods described herein also limits access to the introduced peripheral device node 286 and/or introduced smart peripheral device node 288 attempting to be onboarded onto the anchor information handling system node 200 and within the peripheral device workspace 285 prior to authorization to be included into the peripheral device workspace 285 from the peripheral device workspace cloud orchestrator server 258. This is done so that seamless onboarding may occur without security issues that may arise during the operative coupling of the introduced peripheral device node 286 and/or introduced smart peripheral device node 288 to the anchor information handling system node 200. Still further, the systems and methods described herein allow for such processes whether the anchor information handling system node 200 is online or offline relative to the peripheral device workspace cloud orchestrator server 258 thereby allowing the user to seamlessly operatively couple the introduced peripheral device node 286 and/or introduced smart peripheral device node 288 to the anchor information handling system node 200 regardless of network status but maintain security of the peripheral device workspace 285 within the enterprise.

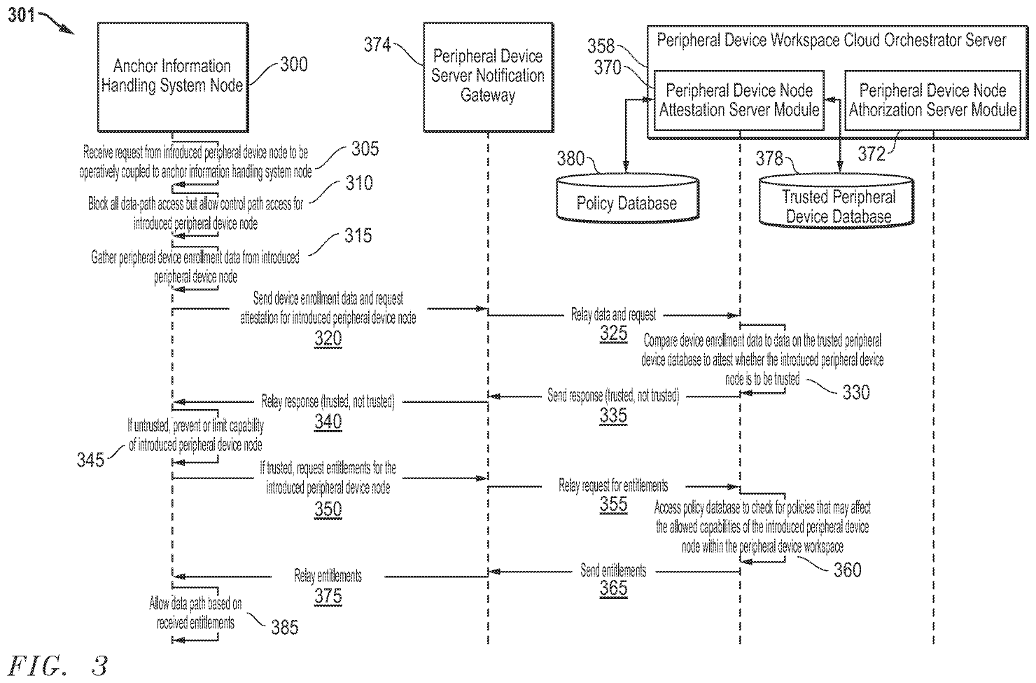

FIG. 3 is a flow chart showing a method 301 of onboarding an introduced peripheral device node into a peripheral device workspace according to an embodiment of the present disclosure. As described herein, the systems and methods described herein describe the attestation of trustworthiness of the introduced peripheral device node (or untrustworthiness) as well as authorization of the introduced peripheral device node such that, where applicable, certain capabilities of the introduced peripheral device node may be restricted or unrestricted based on policies associated with that type of introduced peripheral device node, its capabilities, and security requirements of one or more nodes in an enterprise peripheral device workspace.

At line 305, the method 301 includes receiving a request from an introduced peripheral device node to be operatively coupled to the anchor information handling system node 300. This request may be broadcasted from a wireless interface adapter associated with the introduced peripheral device node and may include security data the provides a secure wireless connection between the introduced peripheral device node and the anchor information handling system node 300 in one embodiment. In another embodiment, a wired connection may be attempted with the anchor information handling system node 300. Other data, including the device enrollment data may also be included in this wireless or wired transmission that describes the make, model, and/or type of peripheral device the introduced peripheral device node is. In an example embodiment, this transmission may also include device identification that may be used to specifically identify the introduced peripheral device node such as a serial number.

At line 310, the anchor information handling system node 300 may block all data-path access requested by the introduced peripheral device node but allow a control path to be initiated between the anchor information handling system node 300 and the introduced peripheral device node. This allows the security of the anchor information handling system node 300 to be maintained until the trustworthiness of the introduced peripheral device node has been attested and the introduced peripheral device node has been authorized to be operatively coupled to the anchor information handling system node 300 and included within the peripheral device workspace.

At line 315, the method 301 includes the anchor information handling system node 300 gathering the peripheral device enrollment data from the introduced peripheral device node. Again, this enrollment data includes peripheral device identifiers such as a serial number, the make, model, and type of the introduced peripheral device node among other identification data.

At line 320, the anchor information handling system node 300 transmits this enrollment data to the peripheral device workspace cloud orchestrator server 358 along with a request that the trustworthiness of the introduced peripheral device node be attested. In an example embodiment, this request may be transmitted through a peripheral device server notification gateway 374 with the peripheral device server notification gateway 374, at line 325, relaying this data and request to the peripheral device workspace cloud orchestrator server 358.

At line 330, the peripheral device workspace cloud orchestrator server 358 executes computer-readable program code of a peripheral device node attestation service module 370. Execution of the peripheral device node attestation service module 370 may attest whether an introduced peripheral device node is a trusted node based on the received peripheral device enrollment data. In an embodiment, the attestation of the introduced peripheral device node may include the peripheral device node attestation service module 370 accessing the data stored on a trusted node database 378 that contains a listing of peripheral devices that have been listed as trusted peripheral device nodes or have been listed as untrusted peripheral device nodes. In an embodiment, because the peripheral device workspace cloud orchestrator server 358 has received peripheral device enrollment data related to the introduced peripheral device node, the execution of the peripheral device node attestation service module 370 causes the peripheral device workspace cloud orchestrator server 358 to compare the peripheral device enrollment data to the data stored on the trusted node database 378.

In an embodiment, the trusted node database 378 may not contain data descriptive of the same or similar introduced peripheral device node and, therefore, the peripheral device workspace cloud orchestrator server 358 cannot attest, on its own, to the trustworthiness of the introduced peripheral device node. In this embodiment, the peripheral device workspace cloud orchestrator server 358 may be provided with access to a third-party database (not shown) that is operated by the manufacturer of the introduced peripheral device node that allows the peripheral device workspace cloud orchestrator server 358 to make the attestation as described herein. Peripheral node device capabilities and operational requirements data may be retrieved from the third party database about the introduced peripheral device. Then the execution of the peripheral device node attestation service module 370 causes the peripheral device workspace cloud orchestrator server 358 to compare the peripheral device enrollment data to security or operational policies established for the anchor information handling system 300, for a particular peripheral device workspace, or those implemented across the enterprise. If the capabilities or operational requirements of the introduced peripheral device node would violate any of these policies, the introduced peripheral device node may be determined as untrusted and may be rejected or have limitations placed on operational entitlements in an embodiment. In other embodiments, the capabilities and operational requirements of the introduced peripheral device node may be reviewed or assessed by an ITDM to determine trustworthiness.

In another embodiment, the trusted node database 378 may include data describing the same or similar peripheral device as that of the introduced peripheral device node seeking to be operatively coupled to the anchor information handling system node 300. In this example, the comparison of the peripheral device enrollment data associated with the introduced peripheral device node may result in the introduced peripheral device node being on an untrusted list of peripheral devices. In this example embodiment, the peripheral device workspace cloud orchestrator server 358 may send, at line 335, a notification to the anchor information handling system node 300 indicating the that introduced peripheral device node is an untrusted peripheral device node and should not be operatively coupled to the anchor information handling system node 100 and included within the peripheral device workspace. This notification is again routed through the peripheral device server notification gateway 374 and relayed by the peripheral device server notification gateway 374 back to the anchor information handling system node 300 at line 340.

In another embodiment, the comparison of the peripheral device enrollment data associated with the introduced peripheral device node may result in the introduced peripheral device node being on a trusted list of peripheral devices. In this example embodiment, the peripheral device workspace cloud orchestrator server 358 may send a notification to the anchor information handling system node 300 indicating the that introduced peripheral device node is a trusted peripheral device node and is allowed to be operatively coupled to the anchor information handling system node 300 and included within the peripheral device workspace. Again, this notification is routed through the peripheral device server notification gateway 374 and relayed by the peripheral device server notification gateway 374 back to the anchor information handling system node 300 at line 340.

Where the peripheral device workspace cloud orchestrator server 358 has sent a notification to the anchor information handling system node 300 that the introduced peripheral device node is an untrusted introduced peripheral device node, the anchor information handling system node 300, at line 345 may prevent or limit the capabilities and functionalities of the introduced peripheral device node.

In an embodiment, the notification of the trustworthiness of the introduced peripheral device node by the peripheral device workspace cloud orchestrator server 358 may be accompanied with operational entitlements that define the actions allowed by the introduced peripheral device node. In order to obtain these entitlements, the anchor information handling system node 300, at lines 350 and 355 may request these entitlements for the introduced peripheral device node via the peripheral device server notification gateway 374.

In an embodiment, in order to provide these operational entitlements, the cloud orchestrator hardware processing device of the peripheral device workspace cloud orchestrator server or servers 258, at line 360, may execute computer-readable program code of a peripheral device node authorization service module 372 that generates the operational entitlements that define the actions allowed by the introduced peripheral device node with respect to the anchor information handling system node 300 at the peripheral device workspace. It is appreciated that, although the introduced peripheral device node may be listed as a trustworthy peripheral device, the data stored on the trusted node database 378 may be modified pursuant to one or more hardware device operational policies created by the ITDM via the peripheral device workspace cloud orchestrator console and stored on the policy database 380. For example, a USB flash drive may be an example of an introduced peripheral device node that is listed on the trusted node database 378 as a trusted peripheral device. However, in order to increase security at an enterprise, the ITDM may have created a hardware device operational policy that mandates that such USB flash drives be limited to read-only status and not be allowed to be written to or to write to a data storage device on the anchor information handling system node 300. This hardware device operational policy may affect the notice (at lines 365 and 375 via the peripheral device server notification gateway 374) sent from the peripheral device workspace cloud orchestrator server 358 to the anchor information handling system node 300 such that the notification indicates to the anchor information handling system node 300 (and possibly the user via a graphical user interface (GUI)) that the operation of the USB flash drive is limited to read-only status or write-only status. This may limit the ability of potentially dangerous malware or computer viruses to be loaded onto the anchor information handling system node 300 or confidential or proprietary data from being downloaded from the anchor information handling system node 300 depending on the hardware device operational policies created by the ITDM at the peripheral device workspace cloud orchestrator console. Thus, the execution of the peripheral device node authorization service module 372 takes into consideration those hardware device operational policies stored on the policy database 380 prior to sending the authorization notification to the anchor information handling system node 100 at lines 365 and 375 via the peripheral device server notification gateway 374.

In an embodiment, where certain functionalities of the introduced peripheral device node are limited, the ITDM may be so notified via the cloud orchestrator video display device of the peripheral device workspace cloud orchestrator console graphical user interface of this limitation on the user's ability to take advantage of all the functionalities of the introduced peripheral device node. In an embodiment, the ITDM may review these limitations and, via use of the cloud orchestrator input device, alter or otherwise override the limitations on the functionalities of the introduced peripheral device node for the user either permanently or for a limited amount of time. This updated hardware device operational policy may be tied to the specific introduced peripheral device node at the specific peripheral device workspace where the user's anchor information handling system node 300 is operating such that an exception is made pursuant to the ITDM's customized policy. As such, the operational entitlements associated with the introduced peripheral device node may be altered by the ITDM and stored, by the peripheral device workspace cloud orchestrator server 358, on the peripheral device workspace database for later review by the peripheral device workspace cloud orchestrator server 358 if and when the introduced peripheral device node is again operatively coupled to the anchor information handling system node 300.

At line 385, the method 301 includes allowing the data path between the introduced peripheral device node and the anchor information handling system node 300 to be opened and used based on the received operational entitlements from the peripheral device workspace cloud orchestrator server 358. At this point, the method 301 may end.

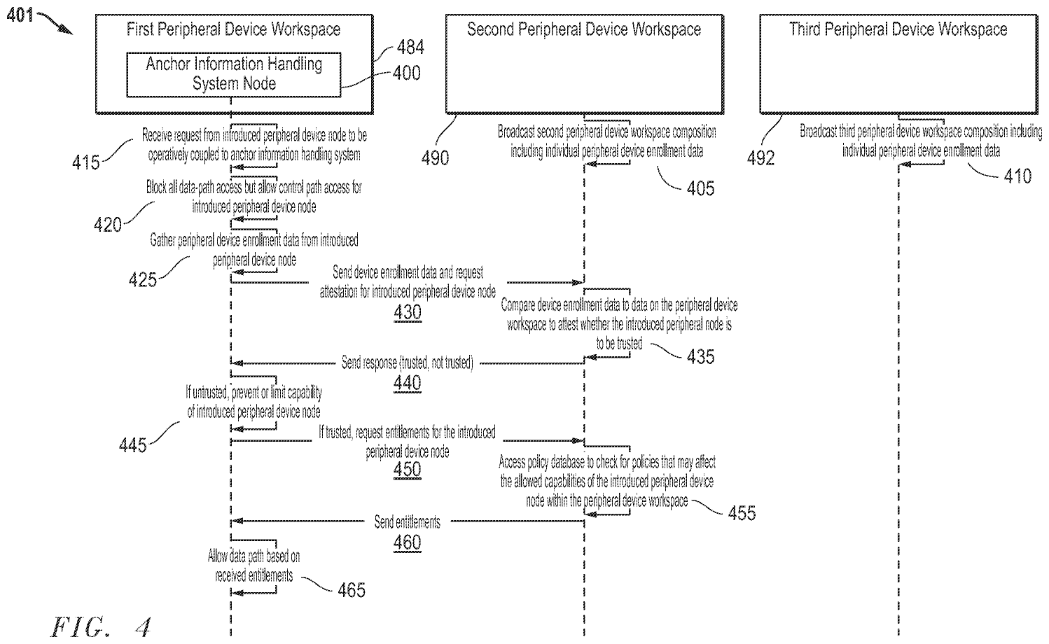

FIG. 4 is a flow chart showing a method 401 of onboarding an introduced peripheral device node into a peripheral device workspace 484 without a network connection between an anchor information handling system 400 and a peripheral device workspace cloud orchestrator server according to another embodiment of the present disclosure. In the embodiment shown in FIG. 4, the anchor information handling system node 400 may be capable of completing the attestation and authorization processes conducted by the peripheral device workspace cloud orchestrator server without the anchor information handling system node 400 being operatively coupled to the peripheral device workspace cloud orchestrator server. In this example embodiment, the anchor information handling system node 400 may rely on data maintained on other user's anchor information handling system nodes that are included within other peripheral device workspaces such as a second peripheral device workspace 490 and/or a third peripheral device workspace 492. It is appreciated that although FIG. 4 shows only two additional peripheral device workspaces 490, 492, the present specification contemplates that any number of additional peripheral device workspaces may be accessible to the first peripheral device workspace 484 of which the anchor information handling system node 400 is located and within which an introduced peripheral device node is seeking to connect.

In an example embodiment, the anchor information handling system node 400 may be operatively coupled to another user's anchor information handling system node 400 via a network connection such that device enrollment data associated with the other user's anchor information handling system node and associated peripheral device nodes at either or both of the second peripheral device workspace 490 and third peripheral device workspace 492 is accessible to the user's anchor information handling system node 200. In an embodiment, a peer discovery mechanism may be implemented to facilitate this communication. These peer discovery mechanisms may include, for example, multicast DNS-based (mDNS-based) peer discovery clusters on a local area network (LAN), link layer discovery protocols (LLDPs), layer 2 neighbor discovery protocols, universal plug and play (UPnP) protocols, network basic input/output system (NetBIOS) and protocol, zero-configuration networking (ZeroConf) protocols, and the like. These types of protocols allow the user's anchor information handling system node 400 to request or receive the broadcasted peripheral device workspace data related to other users' peripheral device workspaces 490, 492 that may include indication of availability for communication to operatively couple to the anchor information handling system node 400 of the first peripheral device workspace. As such, at lines 405 and 410, the anchor information handling system nodes of the second peripheral device workspace 490 and third peripheral device workspace 492 may broadcast their availability for peer-to-peer communication among a community of peripheral device workspaces that include the first peripheral device workspace 484 and its anchor information handling system node 400. This community of peripheral device workspaces 484, 490, and 492 may all be peripheral device workspaces of an enterprise under management of a peripheral device workspace cloud orchestrator according to various embodiments herein.

In an embodiment, the method 401 may include, at line 415, receiving a request from an introduced peripheral device node to be operatively coupled to the anchor information handling system node 400. This request may be broadcasted from a wireless interface adapter associated with the introduced peripheral device node and may include security data the provides a secure wireless connection between the introduced peripheral device node and the anchor information handling system node 400. In other embodiments, an introduced peripheral device node may be operatively coupled via a wired connection to the anchor information handling system node 400 in peripheral device workspace 484. Other data, including the device enrollment data may also be included in this wireless or wired transmission that describes the make, model, and/or type of peripheral device the introduced peripheral device node is. In an example embodiment, this transmission may also include device identification that may be used to specifically identify the introduced peripheral device node such as a serial number.

At line 420, the method 400 includes the anchor information handling system node 400 blocking all data-path access requested by the introduced peripheral device node but allow a control path to be initiated between the anchor information handling system node 400 and the introduced peripheral device node. This allows the security of the anchor information handling system node 400 to be maintained until the trustworthiness of the introduced peripheral device node has been attested and the introduced peripheral device node has been authorized to be operatively coupled to the anchor information handling system node 400 and included within the peripheral device workspace.

At line 425, the method 401 also includes the anchor information handling system node 400 gathering the peripheral device enrollment data from the introduced peripheral device node. Execution of code instructions of a peripheral device node authorization sub-agent and a peripheral device node attestation sub-agent at the anchor information handling system node 400 may access and gather this peripheral device enrollment data for the introduced peripheral device node via the limited control path. Again, this enrollment data includes peripheral device identifiers such as a serial number, the make, model, and type of the introduced peripheral device node among other identification data.

Having access to this device enrollment data, the anchor information handling system node 400 may execute computer-readable program code of a peripheral device node attestation sub-agent and a peripheral device node authorization sub-agent to complete the tasks similar to those executed by the operation of the peripheral device node attestation service module and peripheral device node authorization service module as described herein. The anchor information handling system node 400 may access communication links with the second peripheral device workspace 490 and third peripheral device workspace 492 described in lines 405 and 410 to provide the peripheral device enrollment data associated with the introduced peripheral device node for determination of whether it matches the device enrollment data associated with any of the peripheral devices currently operatively coupled to each of the other anchor information handling system nodes at these other peripheral device workspaces 490, 492. The anchor information handling system node 400 may do this at line 430 by sending the device enrollment data related to the introduced peripheral device node to any given peripheral device workspace 490, 492 along with a request for attestation for the introduced peripheral device node. In one embodiment, the other anchor information handling system nodes within other peripheral device workspaces 490, 482 may access to the peripheral device workspace cloud orchestrator server and may relay this information and request to the peripheral device workspace cloud orchestrator server on behalf of the anchor information handling system node 400. In another embodiment, although the anchor information handling system node 400 may not have access to the peripheral device workspace cloud orchestrator server, other anchor information handling system nodes within other peripheral device workspaces 490, 482 may access their internal manifest of peripheral device nodes via execution of code instructions for a match. In another embodiment, the anchor information handling system node 400 may utilize processing resources of the anchor information handling system node on the other peripheral device workspaces 490, 492 in order to compare the device enrollment data associated with the introduced peripheral device node to enrollment data associated with any of the peripheral devices within each of the second peripheral device workspace 490 and/or third peripheral device workspace 492 in order to make the comparison at line 435.

In an embodiment, a comparison response may be sent back to the anchor information handling system node 400 at line 440. Alternatively in some embodiments, the hardware processor of the anchor information handling system node 400 may simply receive enrollment data of existing peripheral devices within the second peripheral device workspace 490 and/or third peripheral device workspace 492 and make this comparison of the device enrollment data at the anchor information handling system node 400 at the first peripheral device workspace 484 instead. In this embodiment, line 440 may be a return of the enrollment data of each peripheral device node within each of the second peripheral device workspace 490 and third peripheral device workspace 492 for the comparison of the device enrollment data at the anchor information handling system node 400.

In the embodiment, where a match of device enrollment data is not present, the hardware processor of the anchor information handling system node 400 may deny access of the introduced peripheral device node to the anchor information handling system node 400 and prevent or limit the functionalities of the introduced peripheral device node at line 445. Where a match is found, however, the introduced peripheral device node may be onboarded into the first peripheral device workspace 484 and operatively coupled to the anchor information handling system node 400.

In an embodiment, the hardware processor of the anchor information handling system node 400 may execute computer-readable program code of a peripheral device node authorization sub-agent to provide operational entitlements for each onboarded introduced peripheral device node. Again, because the anchor information handling system node 400 is not operatively coupled to the peripheral device workspace cloud orchestrator server, the peripheral device enrollment data and, specifically, corresponding operational entitlements of other peripheral device nodes within other users' peripheral device workspaces 490, 492 may be used by the peripheral device node authorization sub-agent to determine the operational entitlements for the introduced peripheral device node. In yet other embodiments, an operational policy may limit operational entitlements of introduced peripheral device nodes that are attested to and authorized this way to a default set of entitlement limitations to protect the enterprise peripheral device workspace nodes at 484 until network access with the peripheral device workspace cloud orchestrator servers are later established.

In an embodiment, execution of the peripheral device node authorization sub-agent causes the anchor information handling system node 400 to send a request for entitlements associated with the peripheral devices within each of the second peripheral device workspace 490 and third peripheral device workspace 492 at line 450. Again, the anchor information handling system node at any of the second peripheral device workspace 490 or third peripheral device workspace 492 may provide access to the peripheral device workspace cloud orchestrator server and act as a go-between between the anchor information handling system node 400 and the peripheral device workspace cloud orchestrator server in an embodiment. In this embodiment, the peripheral device workspace cloud orchestrator server may provide the necessary entitlement data used by the peripheral device node authorization sub-agent to provide entitlements to the functions and capabilities of the introduced peripheral device node. Alternatively, the entitlement data associated with each of the peripheral devices within the second peripheral device workspace 490 and/or third peripheral device workspace 492 may be used to provide the entitlements to the anchor information handling system node 400. This may be done either via the anchor information handling system nodes of the second peripheral device workspace 490 or third peripheral device workspace 492 or by a hardware processing device of the anchor information handling system node 400. In an embodiment, the entitlement data may be sent from the second peripheral device workspace 490 and/or third peripheral device workspace 492 at line 460.

After reviewing the operational entitlements associated with these other peripheral devices within the other peripheral device workspaces or any deployed default operational entitlements, the peripheral device node authorization sub-agent may, at line 465 onboard the introduced peripheral device node, prevent onboarding of the introduced peripheral device node due to lack of identifiable operational entitlements, or onboard the introduced peripheral device node into the user's peripheral device workspace 484 with limitations to the functionalities of the introduced peripheral device node. When the user's anchor information handling system node 400 is once again operatively coupled to the peripheral device workspace cloud orchestrator server, the execution of the peripheral device node attestation service module and peripheral device node authorization service module as described herein may again take place in order to confirm the onboarding or notify the ITDM, via the cloud orchestrator video display device of the peripheral device workspace cloud orchestrator console, of the limited functionalities of the introduced peripheral device node and/or introduced smart peripheral device node. At this point, the method 401 may end.

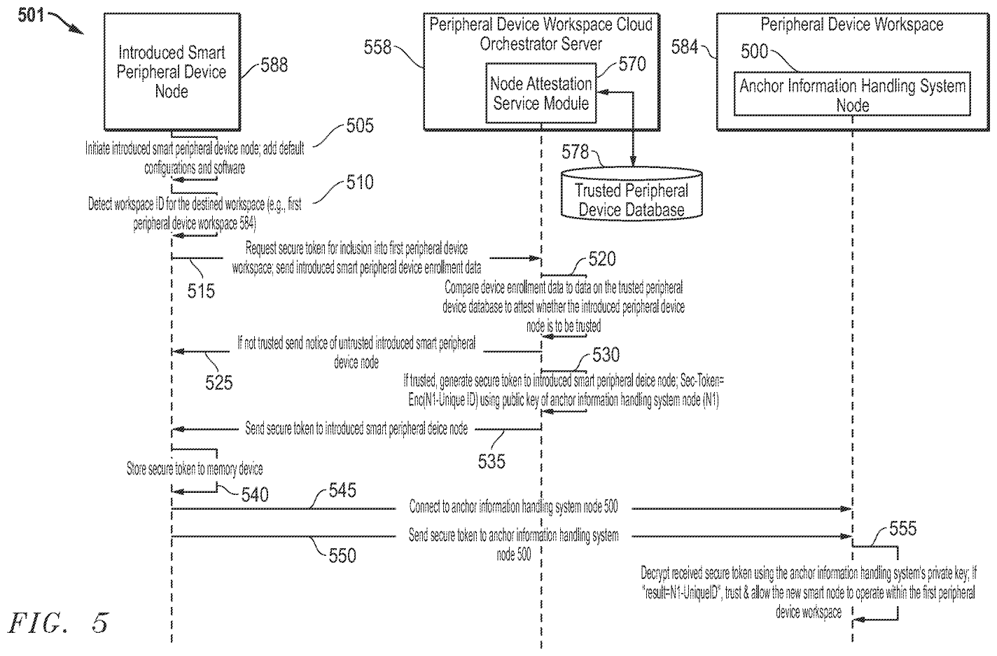

FIG. 5 is a flow chart showing a method 501 of onboarding an introduced smart peripheral device node 588 into a peripheral device workspace according to another embodiment of the present disclosure. As described herein, the introduced peripheral device node may be an introduced smart peripheral device node 588. An introduced smart peripheral device node 588 may be an introduced peripheral device node that includes, at least, networking capabilities that allow the introduced smart peripheral device node 588 to access the peripheral device workspace cloud orchestrator server 558 itself without the need for the user's anchor information handling system node 500 to access the peripheral device workspace cloud orchestrator server 558. In the example embodiment shown in FIG. 5, the anchor information handling system node 500 may not have access to the peripheral device workspace cloud orchestrator server 558 via a network connection at the time the introduced smart peripheral device node 588 seeks to operatively couple. In an embodiment, the introduced smart peripheral device node 588 may act on its own behalf in order to onboard the introduced smart peripheral device node 588 into the peripheral device workspace 584 and operatively couple the introduced smart peripheral device node 588 to the anchor information handling system node 500. This may have occurred before the introduced smart peripheral device node 588 was brought into the peripheral device workspace 584 in some embodiments.

The method 501 may include, at line 505, the introduced smart device node 588 being initiated by, for example, a user pressing a power button on the introduced smart peripheral device node 588. This initiation may cause, in some embodiments, the introduced smart peripheral device node 588 to execute, add, or otherwise initiate an operating system and BIOS that adds default configurations and executes default software using a hardware processing device within the introduced smart peripheral device node 588.

At line 510, the introduced smart peripheral device node 588 may detect a workspace identification value for the peripheral device workspace 584 that includes the anchor information handling system node 500 or may have received the peripheral device workspace identification value for the peripheral device workspace 584 before arriving. Because the user may be associated with a specific peripheral device workspace 584 at the peripheral device workspace database, this data may be received from the peripheral device workspace cloud orchestrator server 558 in an embodiment, for example, in anticipation of entering the peripheral device workspace 584. In another embodiment, the peripheral device workspace identification value may be received from the anchor information handling system node 500.

In an embodiment, at line 515, the introduced smart peripheral device node 588 may communicate peripheral device enrollment data associated with the introduced smart peripheral device node to the peripheral device workspace cloud orchestrator server 558 for the peripheral device workspace cloud orchestrator server 558 to execute the peripheral device node attestation service module 570 as described herein. This sending of the peripheral device enrollment data may be accompanied with a request for a secure token to be sent from the peripheral device workspace cloud orchestrator server 558 to the introduced smart peripheral device node 588.

At line 520, the execution of the peripheral device node attestation service module 570 may attest whether an introduced peripheral device node is a trusted node based on the received peripheral device enrollment data. In an embodiment, the attestation of the introduced peripheral device node may include the peripheral device node attestation service module 570 accessing the data stored on a trusted node database 578 that contains a listing of peripheral devices that have been listed as trusted peripheral device nodes and have been listed as untrusted peripheral device nodes. In an embodiment, because the peripheral device workspace cloud orchestrator server 558 has received peripheral device enrollment data related to the introduced peripheral device node, the execution of the peripheral device node attestation service module 570 causes the peripheral device workspace cloud orchestrator server 558 to compare the peripheral device enrollment data to the data stored on the trusted node database 578.

Where the comparison of the peripheral device enrollment data does match details of an untrusted introduced smart peripheral device node 588, the peripheral device workspace cloud orchestrator server 558 may, at line 525, send a notification to the introduced smart peripheral device node 588. This notification may indicate that the introduced smart peripheral device node 588 is not a trusted introduced smart peripheral device node 588 and may not be provided with the secure token as requested.

At line 530, where the comparison of the peripheral device enrollment data matches details of trusted peripheral devices stored in the trusted node database 578, the cloud orchestrator hardware processing device of the peripheral device workspace cloud orchestrator server 558 may execute the computer-readable code of the peripheral device node authorization service module (not shown) to determine what operational entitlements the introduced smart peripheral device node is to be awarded. In an example embodiment, the operational entitlements may be associated with a secure token and sent to the introduced smart peripheral device node 588.

At this point, the introduced smart peripheral device node may, at line 540, store the secure token to a memory device within the introduced smart peripheral device node 588 for later user with the anchor information handling system node 500. At line 545, the introduced smart peripheral device node 588 may connect to the anchor information handling system node 500 to accomplish this task.

At line 550, the introduced smart peripheral device node 588 may send the operational entitlements and secure token to the hardware processor of the anchor information handling system node 500 such that the anchor information handling system node 500 can verify that the introduced smart peripheral device node has been attested and authorized to be operatively coupled to the anchor information handling system node 500. In an embodiment, the secure token may be generated by the peripheral device workspace cloud orchestrator server using a public key associated with the anchor information handling system node 500 and known to the peripheral device workspace cloud orchestrator server 558.

With that public key-created secure token, the introduced smart peripheral device node 588 may present this secure token to the anchor information handling system node 500 upon which, the anchor information handling system node 500 uses a counterpart private key previously placed thereon to decrypt the secure key received at line 555. Where the private key cannot be used to decrypt the secure token, the introduced smart peripheral device node 588 is not operatively coupled to the anchor information handling system node 500. However, the where private key successfully decrypts the secure token, the introduced smart peripheral device node 588 is operatively coupled to the anchor information handling system node 500 and included as a smart device node within the peripheral device workspace 584. Further, any operational entitlements that apply to the introduced smart peripheral device node 588 may also be transferred and implemented by the anchor node information handling system node 500 in the peripheral device workspace 584. At this point, the method 501 may end.

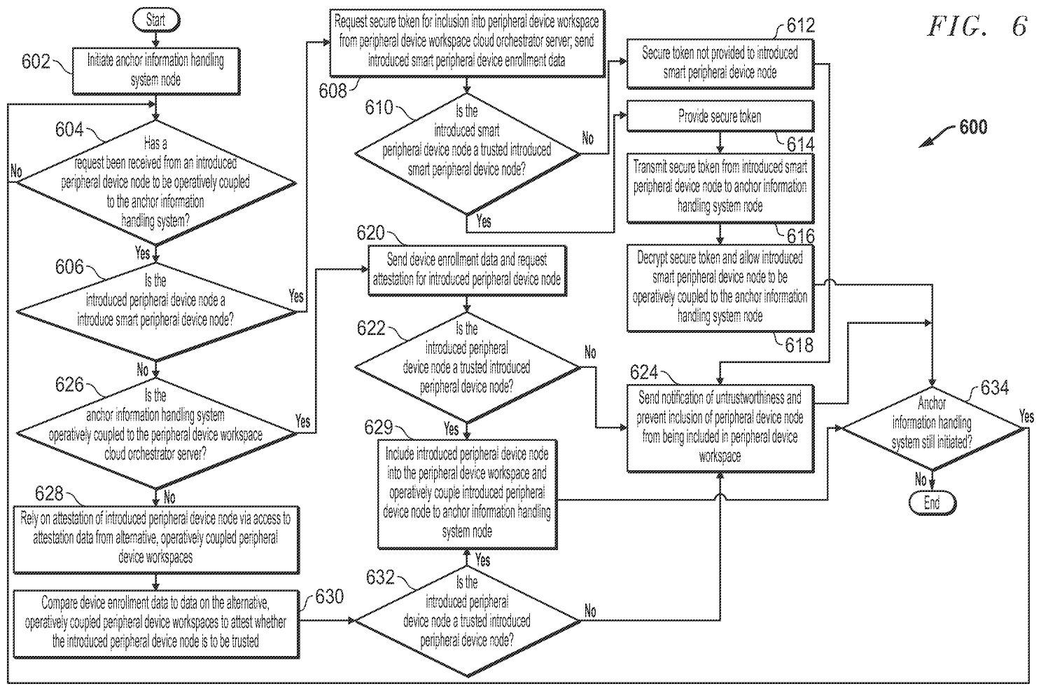

FIG. 6 is a flow chart showing a method 600 of onboarding an introduced peripheral device node into a peripheral device workspace according to another embodiment of the present disclosure. As described herein, the systems and methods are applicable to the onboarding of introduced peripheral device nodes as well as onboarding of introduced smart peripheral device nodes whether the anchor information handling system node is operatively coupled to the peripheral device workspace cloud orchestrator server via a network connection or not.

At block 602, the method 600 includes initiating the anchor information handling system. In an embodiment, the initiation of the anchor information handling system may include the user actuating a power button such that the BIOS and OS of the anchor information handling system node are booted up. At this point, the anchor information handling system node may monitor for attempts by introduced peripheral device nodes or introduced smart peripheral device nodes to be operatively coupled to the anchor information handling system node. It is appreciated that that the user may cause the introduced peripheral device node and/or introduced smart peripheral device node to be operatively coupled to the anchor information handling system node by initiating a wireless coupling of the introduced peripheral device node and/or introduced smart peripheral device node to the anchor information handling system node or by coupling the introduced peripheral device node and/or introduced smart peripheral device node to the anchor information handling system node via a wired connection.

At block 604, the method 600 includes determining whether a request from an introduced peripheral device node and/or introduced smart peripheral device node has been received by the anchor information handling system node. Where no request has been received, the method 600 may include the anchor information handling system node continuing to monitor for such requests. However, where the request was made, the method 600 continues to block 606.

At block 606, the anchor information handling system node (and concurrently, the introduced smart peripheral device node) may determine if the introduced peripheral device node is an introduced smart peripheral device node. As described herein, an introduced smart peripheral device node may be an introduced peripheral device node that includes, at least, networking capabilities that allow the introduced smart peripheral device node to access the peripheral device workspace cloud orchestrator server itself without the need for the user's anchor information handling system node to access the peripheral device workspace cloud orchestrator server.

Where the anchor information handling system node and introduced smart peripheral device node has determined that the introduced peripheral device node is an introduced smart peripheral device node at block 606, the method 600 may include similar processes as that described in connection with FIG. 5. In this embodiment, the method 600 continues to block 608 with the introduced smart peripheral device node (e.g., a docking station) requesting a secure token for inclusion into peripheral device workspace from peripheral device workspace cloud orchestrator server and sending the introduced smart peripheral device enrollment data. In an embodiment, the introduced smart peripheral device node may detect a peripheral device workspace identification value for the peripheral device workspace that includes the anchor information handling system node. Because the user may be associated with a specific peripheral device workspace at the peripheral device workspace database, this data may be received from the peripheral device workspace cloud orchestrator server in an embodiment, for example, in anticipation that the smart peripheral device node will be entering the peripheral device workspace. In another embodiment, the peripheral device workspace identification value may be received from the anchor information handling system node by the introduced smart peripheral device node.

In an embodiment, the introduced smart peripheral device node may communicate the peripheral device enrollment data associated with the introduced smart peripheral device node to the peripheral device workspace cloud orchestrator server for the peripheral device workspace cloud orchestrator server to execute the peripheral device node attestation service module as described herein. The execution of the peripheral device node attestation service module may attest whether an introduced peripheral device node is a trusted node based on the received peripheral device enrollment data. In an embodiment, the attestation of the introduced peripheral device node may include the peripheral device node attestation service module accessing the data stored on a trusted node database that contains a listing of peripheral devices that have been listed as trusted peripheral device nodes and have been listed as untrusted peripheral device nodes. In an embodiment, because the peripheral device workspace cloud orchestrator server has received peripheral device enrollment data related to the introduced peripheral device node, the execution of the peripheral device node attestation service module causes the peripheral device workspace cloud orchestrator server to compare the peripheral device enrollment data to the data stored on the trusted node database.

At block 610, where the comparison of the peripheral device enrollment data matches details of an untrusted introduced smart peripheral device node, the peripheral device workspace cloud orchestrator server may not send a secure token to the introduced smart peripheral device node at block 612. In an embodiment, the peripheral device workspace cloud orchestrator server may also send, at block 624, a notification of untrustworthiness and prevent inclusion of the introduced smart peripheral device node from being included in peripheral device workspace.

However, where the comparison of the peripheral device enrollment data matches details of trusted peripheral devices stored in the trusted node database at block 610, the method 600 includes the cloud orchestrator hardware processing device of the peripheral device workspace cloud orchestrator server executing the computer-readable code of the peripheral device node authorization service module to generate and provide a secure token. As described herein, the peripheral device workspace cloud orchestrator server may also determine what operational entitlements the introduced smart peripheral device node is to be awarded. In an example embodiment, the operational entitlements may be associated with a secure token and sent to the introduced smart peripheral device node. In an embodiment, the secure token is created by encrypting the entitlements and authorization signal using a public key of the anchor information handling system node that is known to the peripheral device workspace cloud orchestrator server. In an embodiment, the introduced smart peripheral device node may store the secure token to a memory device, as well as any issued operational entitlements requirements, within the introduced smart peripheral device node for later user with the anchor information handling system node. At block 616, the secure token or a counterpart thereof for decryption may be transmitted to the anchor information handling system node by the introduced smart peripheral device node for onboarding of the introduced smart peripheral device node into the peripheral device workspace. In various embodiments, the anchor information handling system node may have pre-provided the secure token or a counterpart thereof for decryption of this or any introduced smart peripheral device when network connectivity was still available at the anchor node information handling system. To conduct the onboarding of the introduced smart peripheral device node into the peripheral device workspace upon decrypting the attestation and authorization as well as any applicable operational entitlement limitations, the anchor information handling system node may decrypt the secure token at block 618 and allow introduced smart peripheral device node to be operatively coupled to the anchor information handling system node. Decryption of the secure token may be done using a private key at the anchor information handling system node to decrypt and verify attestation of trustworthiness, authorization of the introduced smart peripheral device node into the peripheral device workspace, and determination of any operational entitlement limitations that may apply.

At this point, the method 600 continues to block 634 with the determination as to whether the anchor information handling system node is still initiated. Where the anchor information handling system node is no longer initiated, the method 600 may end here. However, where the anchor information handling system node is still initiated, the method 600 may return to block 604 to continue to monitor for other request for other introduced peripheral device nodes to be operatively coupled to the anchor information handling system node.

Returning to block 606, where the introduced peripheral device node is determined to not be an introduced smart peripheral device node, the method 600 continues to block 626 to determine if the anchor information handling system node is operatively coupled to the peripheral device workspace cloud orchestrator server via a network connection. Where, at block 626, the anchor information handling system node is operatively coupled to the peripheral device workspace cloud orchestrator server, the method 600 may complete similar processes as those described in connection with FIG. 3 here.

In an embodiment, the method 600 includes sending the device enrollment data and request for attestation of the introduced peripheral device node to the peripheral device workspace cloud orchestrator server at block 620. In an embodiment, the peripheral device workspace cloud orchestrator server, having received the device enrollment data and request for attestation, executes computer-readable program code of a peripheral device node attestation service module. Execution of the peripheral device node attestation service module may attest whether an introduced peripheral device node is a trusted node based on the received peripheral device enrollment data. In an embodiment, the attestation of the introduced peripheral device node may include the peripheral device node attestation service module accessing the data stored on a trusted node database that contains a listing of peripheral devices that have been listed as trusted peripheral device nodes and have been listed as untrusted peripheral device nodes. In an embodiment, because the peripheral device workspace cloud orchestrator server has received peripheral device enrollment data related to the introduced peripheral device node, the execution of the peripheral device node attestation service module causes the peripheral device workspace cloud orchestrator server to compare the peripheral device enrollment data to the data stored on the trusted node database.

In one embodiment, the trusted node database may not contain data descriptive of the same or similar introduced peripheral device node and, therefore, the peripheral device workspace cloud orchestrator server cannot attest, on its own, to the trustworthiness of the introduced peripheral device node. In this embodiment, the peripheral device workspace cloud orchestrator server may be provided with access to a third-party database that is operated by the manufacturer of the introduced peripheral device node that allows the peripheral device workspace cloud orchestrator server to receive identification information as well as capabilities and operational requirements for the introduced peripheral device node seeking to operably couple to the anchor information handling system node. With this data, the peripheral device workspace cloud orchestrator server may compare these capabilities and operational requirements to operational policies in place for the anchor information handling system, the peripheral device workspace, or across the enterprise for security purposes or operational reasons and then make the attestation based upon detection of a violation of those policies or matching of those policies as described herein. This may similarly be used to determine any operational entitlements or limitations that may be applied to the introduced peripheral device node where applicable.

In another embodiment, the trusted node database may include data describing the same or similar peripheral device as that of the introduced peripheral device node seeking to be operatively coupled to the anchor information handling system node. In this example, the comparison of the peripheral device enrollment data associated with the introduced peripheral device node may result in the introduced peripheral device node being on an untrusted list of peripheral devices and therefor defined as an untrusted introduced peripheral device node. Thus, at block 622, the peripheral device workspace cloud orchestrator server may determine that the introduced peripheral device node is not trusted causing the method 600 to proceed to block 624 to execute those processes for notification of untrustworthiness and prevention of inclusion of the introduced peripheral device node as described herein.

However, at block 622, the peripheral device workspace cloud orchestrator server determines that the introduced peripheral device node is a trusted introduced peripheral device node, the method 600 continues to block 629. At block 629, the peripheral device workspace cloud orchestrator server may send a notification to the anchor information handling system node indicating that the introduced peripheral device node is a trusted peripheral device node and is allowed to be operatively coupled to the anchor information handling system node and included within the peripheral device workspace. In an embodiment, this notification may be routed through a peripheral device server notification gateway and relayed by the peripheral device server notification gateway back to the anchor information handling system node.

In an embodiment, the notification of the trustworthiness of the introduced peripheral device node by the peripheral device workspace cloud orchestrator server may be accompanied with operational entitlements that define the actions allowed by the introduced peripheral device node. In order to obtain these entitlements, the anchor information handling system node may request these entitlements, or any limitations thereto, for the introduced peripheral device node via the peripheral device server notification gateway as described herein. In an embodiment, in order to provide these operational entitlements, the cloud orchestrator hardware processing device of the anchor information handling system node may execute computer-readable program code of a peripheral device node authorization service module that generates the operational entitlements that define the actions allowed by the introduced peripheral device node.

Returning to block 626 where the anchor information handling system node has determined that the anchor information handling system node is not operatively coupled to the peripheral device workspace cloud orchestrator server, the method 600 includes, at bock 628, relying on attestation of the introduced peripheral device node via access to attestation data from alternative, operatively coupled peripheral device workspaces. As described herein, a peer discovery mechanism may be implemented to facilitate this communication between the anchor information handling system node and other users' anchor information handling system nodes within other, alternative peripheral device workspaces. These alternative peripheral device workspaces may be any other peripheral device workspace in an enterprise and managed by the peripheral device workspace cloud orchestrator servers in example embodiments. These peer discovery mechanisms may include, for example, multicast DNS-based (mDNS-based) peer discovery clusters on a local area network (LAN), link layer discovery protocols (LLDPs), layer 2 neighbor discovery protocols, universal plug and play (UPnP) protocols, network basic input/output system (NetBIOS) and protocol, zero-configuration networking (ZeroConf) protocols, and the like. These types of protocols allow the user's anchor information handling system node at a first peripheral device workspace to request or broadcast data relating to the introduced peripheral device node and other workspace data to other users' peripheral device workspaces that may include a similar type, make, or model, as the introduced peripheral device node the user is attempting to operatively couple to the anchor information handling system node. The anchor information handling system node at the first peripheral device workspace may broadcast identification data and capabilities data of the introduced peripheral device node along with a request for attestation and potentially authorization from other peripheral device workspaces and their anchor information handling system nodes in an embodiment.

At block 630, the method 600 includes comparing device enrollment data associated with the introduced peripheral device node to other device enrollment data associated with other peripheral devices within other peripheral device workspaces to attest whether the introduced peripheral device node is to be trusted. In an embodiment, this comparison may be made by the hardware processing devices at the anchor information handling system nodes within the other peripheral device workspaces executing code instructions of a peripheral device node authorization sub-agent or a peripheral device node attestation sub-agent. In yet other embodiments, if one or more alternative other peripheral device workspaces have network connectivity to the peripheral device workspace cloud orchestrator servers, the request for attestation and authorization may be forwarded by the anchor node at the alternative peripheral device workspace for determination of trusted or untrusted determinations. In yet another embodiment, the anchor information handling system node at the first peripheral device workspace may receive peripheral device node data and trustworthiness status from one or more alternative peripheral device workspaces from the enterprise for comparison at the anchor information handling system node to determine if a match exists before onboarding the introduced peripheral device node to the first peripheral device workspace.

Proceeding to block 632, the method 600 includes determining whether the introduced peripheral device node is a trusted introduced peripheral device node. Where the anchor information handling system node has determined that the introduced peripheral device node is a trusted introduced peripheral device node, the method 600 proceeds to block 629 to complete the processes described herein to include the introduced peripheral device node in the first peripheral device workspace and apply any operational entitlements or limitations of the same to the introduced peripheral device node. The method 600 may then proceed to block 634.

Where the anchor information handling system node determines that the introduced peripheral device node is not a trusted introduced peripheral device node, the method 600 proceeds to block 624 for execution of those processes described herein to generated a notification of untrustworthiness and to block inclusion of the introduced peripheral device node. The method 600 may then proceed to block 634.

At block 634, a determination is then made as to whether the anchor information handling system node is still initiated. Where the anchor information handling system node is no longer initiated, the method 600 may end here. However, where the anchor information handling system node is still initiated, the method 600 may return to block 604 to continue to monitor for other request for other introduced peripheral device nodes to be operatively coupled to the anchor information handling system node.

The blocks of the flow diagrams of FIGS. 4-6 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A peripheral device workspace cloud orchestrator server, comprising:
a hardware processor;
a memory device;
a power management unit (PMU) to provide power to the hardware processor and memory device; and
a network interface device to receive detected introduced peripheral device enrollment data describing an introduced peripheral device node that has requested to be operatively coupled to an anchor information handling system node within a peripheral device workspace managed by the peripheral device workspace cloud orchestrator server, the anchor information handling system node operatively coupled to the peripheral device workspace cloud orchestrator server and identified as being included within the peripheral device workspace;
the hardware processor to execute computer-readable program code of a node attestation service module to attest whether the introduced peripheral device node is a trusted node based on the received introduced peripheral device enrollment data; and
the hardware processor to execute computer-readable program code of a node authorization service module to provide operational entitlements that define executable operating actions allowed by the introduced peripheral device node in the peripheral device workspace, wherein the peripheral device workspace includes a location having a location identifier, the anchor information handling system, and a manifest of a plurality of peripheral device nodes operatively coupled to the anchor information handling system node at the location.

2. The peripheral device workspace cloud orchestrator server of claim 1 further comprising:
a peripheral device workspace cloud orchestrator executing at the peripheral device workspace cloud orchestrator server to receive input from an internet technology decision maker (ITDM) to create hardware device operational policies to be applied to each peripheral device node within the peripheral device workspace, and to create the operational entitlements for the introduced peripheral device node within the peripheral device workspace to correspond with the hardware device operational policies.

3. The peripheral device workspace cloud orchestrator server of claim 1 further comprising:
a trusted node database operatively coupled to the peripheral device workspace cloud orchestrator server, wherein the execute computer-readable program code of a node attestation service module by the hardware processor of the peripheral device workspace cloud orchestrator server cross-references the detected peripheral device enrollment data describing the introduced peripheral device node with a list of trusted peripheral devices to attest whether the introduced peripheral device node is a trusted node based on the received peripheral device enrollment data.

4. The peripheral device workspace cloud orchestrator server of claim 1 further comprising:
the hardware processor of the peripheral device workspace cloud orchestrator server to execute computer-readable program code of a cloud manageability orchestrator module to:
assign a peripheral device workspace identification value to the peripheral device workspace and store that peripheral device workspace identification value on a peripheral device workspace database.

5. The peripheral device workspace cloud orchestrator server of claim 1 further comprising:
the hardware processor to execute computer-readable program code of the node authorization service module to generate a notification to the anchor information handling system node indicating whether the introduced peripheral device node should be onboarded into the peripheral device workspace and operatively coupled to the anchor information handling system node.

6. The peripheral device workspace cloud orchestrator server of claim 1, wherein the hardware processor receives the device enrollment data from the anchor information handling system node including a hardware processor executing a node attestation sub-agent that gathers the detected peripheral device enrollment data from the introduced peripheral device node prior to the introduced peripheral device node being onboarded into the peripheral device workspace.

7. The peripheral device workspace cloud orchestrator server of claim 1 further comprising:
the hardware processor to execute computer code of a cloud manageability orchestrator module to create and link peripheral device workspace identification values with a user composite peripheral device workspace identifier that identifies a user of the anchor information handling system node within the peripheral device workspace identified by the peripheral device workspace identification values.

8. The peripheral device workspace cloud orchestrator server of claim 1, wherein the detected introduced peripheral device enrollment data gathered at the peripheral device workspace database includes:
introduced peripheral device capability data;
introduced peripheral device connectivity data;
current introduced peripheral device settings;
introduced peripheral device setting options; and
current status of the introduced peripheral device.

9. A method of onboarding an introduced peripheral device node into a peripheral device workspace comprising:
receiving, via a network interface device of a peripheral device workspace cloud orchestrator server, detected peripheral device enrollment data describing an introduced peripheral device node that has requested to be operatively coupled to an anchor information handling system node within the peripheral device workspace, the anchor information handling system node operatively coupled to the peripheral device workspace cloud orchestrator server and identified as being included within the peripheral device workspace;
executing computer-readable program code of a node attestation service module to attest whether the introduced peripheral device node is a trusted node based on the received peripheral device enrollment data; and
executing computer code of a node authorization service module to provide operational entitlements that define executable operating actions allowed by the introduced peripheral device node within the peripheral device workspace, wherein the peripheral device workspace includes a location having a location identifier, the anchor information handling system, and a manifest of a plurality of peripheral device nodes operatively coupled to the anchor information handling system node at the location.

10. The method of claim 9 further comprising:
receiving hardware device operational policies at the peripheral device workspace cloud orchestrator server to be applied to each peripheral device node within the peripheral device workspace; and
generating the operational entitlements for the introduced peripheral device node within the peripheral device workspace to meet the hardware device operational policies.

11. The method of claim 9, further comprising:
executing the executable computer-readable program code of a node attestation service module by the hardware processor of the peripheral device workspace cloud orchestrator server to cross-reference the detected peripheral device enrollment data describing the introduced peripheral device node with a list of trusted peripheral devices in a trusted node database operatively coupled to the peripheral device workspace cloud orchestrator server to attest whether the introduced peripheral device node is a trusted node based on the received peripheral device enrollment data.

12. The method of claim 9 further comprising:
the hardware processor of the peripheral device workspace cloud orchestrator server to execute computer-readable program code of a cloud manageability orchestrator module to:
assign a peripheral device workspace identification value to the peripheral device workspace and store that peripheral device workspace identification value on a peripheral device workspace database;
receive firmware and software updates created based on policies held within a policy database operatively coupled to the peripheral device workspace cloud orchestrator server; and
apply the firmware and software updates to individual peripheral device nodes within the peripheral device workspace.

13. The method of claim 9 further comprising:
the hardware processor to execute computer-readable program code of the node authorization service module to generate a notification to the anchor information handling system node indicating whether the introduced peripheral device node should be onboarded into the peripheral device workspace and operatively coupled to the anchor information handling system node.

14. The method of claim 9, wherein the hardware processor receives the device enrollment data from an anchor node hardware processor executing a node attestation sub-agent at the anchor information handling system node that gathers the detected peripheral device enrollment data from the introduced peripheral device node prior to the introduced peripheral device node being onboarded into the peripheral device workspace.

15. The method of claim 9 further comprising:
the hardware processor to execute computer code of a cloud manageability orchestrator module to create and link peripheral device workspace identification values with a user composite peripheral device workspace identifier that identifies a user of the anchor information handling system node within the peripheral device workspace identified by the peripheral device workspace identification values for identification of hardware device operational policies applicable to the user.

16. A peripheral device workspace cloud orchestrator server, comprising:
a hardware processor;
a memory device;
a power management unit (PMU) to provide power to the hardware processor and memory device; and
a network interface device to receive detected peripheral device enrollment data describing an introduced peripheral device node that has requested to be operatively coupled to an anchor information handling system node within a peripheral device workspace, the anchor information handling system node operatively coupled to the peripheral device workspace cloud orchestrator server and identified as being included within the peripheral device workspace;
the hardware processor to execute computer-readable program code of a node attestation service module to attest whether the introduced peripheral device node is a trusted node based on the received peripheral device enrollment data;
the hardware processor to execute computer-readable program code of a node authorization service module to provide operational entitlements that define executable operational actions allowed by the introduced peripheral device node; and
the hardware processor to execute computer-readable program code of the node authorization service module to generate a notification to the anchor information handling system node indicating whether the introduced peripheral device node is trusted and should be onboarded into the peripheral device workspace and operatively coupled to the anchor information handling system node, wherein the peripheral device workspace includes a location having a location identifier, the anchor information handling system, and a manifest of a plurality of peripheral device nodes operatively coupled to the anchor information handling system node at the location.

17. The peripheral device workspace cloud orchestrator server of claim 16 further comprising:
the hardware processor of the peripheral device workspace cloud orchestrator server to execute computer-readable program code of a cloud manageability orchestrator module to:
assign a peripheral device workspace identification value to the peripheral device workspace and store that peripheral device workspace identification value on a peripheral device workspace database;
receive firmware and software updates created based on policies held within a policy database operatively coupled to the peripheral device workspace cloud orchestrator server; and
apply the firmware and software updates to individual peripheral device nodes within the peripheral device workspace.

18. The peripheral device workspace cloud orchestrator server of claim 16 further comprising:
a trusted node database operatively coupled to the peripheral device workspace cloud orchestrator server; and
the hardware processor to execute the computer-readable program code of the node attestation service module to cross-reference the detected peripheral device enrollment data describing the introduced peripheral device node with a list of trusted peripheral devices to attest whether the introduced peripheral device node is a trusted node based on the received peripheral device enrollment data.

19. The peripheral device workspace cloud orchestrator server of claim 16 further comprising:
the peripheral device workspace cloud orchestrator server to receive input from an internet technology decision maker (ITDM) to create hardware device operational policies to be applied to each peripheral device node within the peripheral device workspace and to create the operational entitlements for the introduced peripheral device node within the peripheral device workspace to meet those hardware device operational policies.

20. The peripheral device workspace cloud orchestrator server of claim 16, wherein the hardware processor receives the device enrollment data from the anchor information handling system node including a hardware processor executing a node attestation sub-agent that gathers the detected peripheral device enrollment data from the introduced peripheral device node prior to the introduced peripheral device node being onboarded into the peripheral device workspace.
